(19) United States
(12) Patent Application Publication
(10) Pub. No.: US 2025/0356805 A1
(43) Pub. Date: Nov. 20, 2025

(54) DISPLAY ARTIFACT MITIGATION USING PULSE DENSITY MAPPING

(71) Applicant: Meta Platforms Technologies, LLC, Menlo Park, CA (US)

(72) Inventor: Ajit Ninan, San Jose, CA (US)

(21) Appl. No.: 19/170,758

(22) Filed: Apr. 4, 2025

Related U.S. Application Data
(60) Provisional application No. 63/575,182, filed on Apr. 5, 2024.

(51) Int. Cl. G09G 3/3233; G09G 3/20

(52) U.S. Cl. CPC G09G 3/3233; G09G 3/2014

(57) ABSTRACT

The disclosed computer-implemented method may include receiving a pulse width value corresponding to a pulse for activating a pixel of a color channel for a frame and dividing the pulse into a plurality of sub-pulses. The method may also include activating the pixel for the frame based on the plurality of sub-pulses. Various other methods, systems, and computer-readable media are also disclosed.

### CROSS REFERENCE TO RELATED APPLICATION

This application claims the benefit of U.S. Provisional Application No. 63/575,182, filed Apr. 5, 2024, the disclosures of which is incorporated, in its entirety, by this reference.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIGS. 1A-1B are diagrams of retinas viewing objects in the real world.

FIGS. 2A-2B are diagrams of retinas viewing objects virtually.

FIGS. 3A-3B are diagrams of another example of retinas viewing objects virtually.

FIGS. 4A-E illustrate example frame views.

FIGS. 5A-B illustrate example frame views.

FIGS. 6A-C illustrate example frame views at a double rate.

FIG. 7A-D illustrates an example of pulse density mapping.

FIG. 8A-D illustrates a timeline comparison for pulse density mapping.

FIG. 9 illustrates an example bitplane-based pulse density mapping scheme.

FIG. 10A-B illustrate example architectures for a counter circuit configuration for a pulse density scheme.

FIGS. 11A-B illustrate an examples of pulse density mapping with respect to pixel shifting.

FIG. 12 illustrates an example architecture for a shifter circuit configuration.

FIG. 13 illustrates an example architecture for in-plane shifting.

FIG. 14 is a flow diagram of an exemplary method for display artifact mitigation using pulse density mapping.

FIG. 15 is an illustration of an example artificial-reality system according to some embodiments of this disclosure.

FIG. 16 is an illustration of an example artificial-reality system with a handheld device according to some embodiments of this disclosure.

FIG. 17A is an illustration of example user interactions within an artificial-reality system according to some embodiments of this disclosure.

FIG. 17B is an illustration of example user interactions within an artificial-reality system according to some embodiments of this disclosure.

FIG. 18A is an illustration of example user interactions within an artificial-reality system according to some embodiments of this disclosure.

FIG. 18B is an illustration of example user interactions within an artificial-reality system according to some embodiments of this disclosure.

FIG. 19 is an illustration of an example wrist-wearable device of an artificial-reality system according to some embodiments of this disclosure.

FIG. 20 is an illustration of an example wearable artificial-reality system according to some embodiments of this disclosure.

FIG. 21 is an illustration of an example augmented-reality system according to some embodiments of this disclosure.

FIG. 22A is an illustration of an example virtual-reality system according to some embodiments of this disclosure.

FIG. 22B is an illustration of another perspective of the virtual-reality systems shown in FIG. 22A.

FIG. 23 is a block diagram showing system components of example artificial- and virtual-reality systems.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

Displays that use pulse width modulation (PWM) to flash a pixel to mix the color or even a backlight will use PWM to turn on an LED. This means the timing of the LED or uLED or miniLED the on time is based on the brightness, e.g., if its low brightness it will be on for a very short time compared to if its bright then it will keep the LED on longer. PWM often uses pulse widths that keep the light source on continuously until it reaches its brightness count and then turns it off. When mixing colors this may be problematic since the RGB light sources/LEDs will turn on at the beginning of the frame together and then the colors with lower brightness for the mix will turn off and leave the brighter primary color on longer. If a user's eye is moving at this turn off time, the remaining on color(s) will streak and cause problems like color breakup and other issues. The same is true for LCOS backlights the R persistence will be different than the G or B or if mixing the colors for a monochrome frame this will cause other visual artifacts.

The technical solution provided herein includes moving from within the frame to light it up differently, e.g., in the single frame light distribution will be proportional in the frame time and to its other colors. The idea is to maintain the ratio and split the over-all time over the frame. This scheme may be referred to herein as Pulse density mapping (PDM) does not take into account maintaining the ratios (e.g., cross correlation of the other colors), which may be needed to avoid a visual artifact called false contouring.

Features from any of the embodiments described herein may be used in combination with one another in accordance with the general principles described herein. These and other embodiments, features, and advantages will be more fully understood upon reading the following detailed description in conjunction with the accompanying drawings and claims.

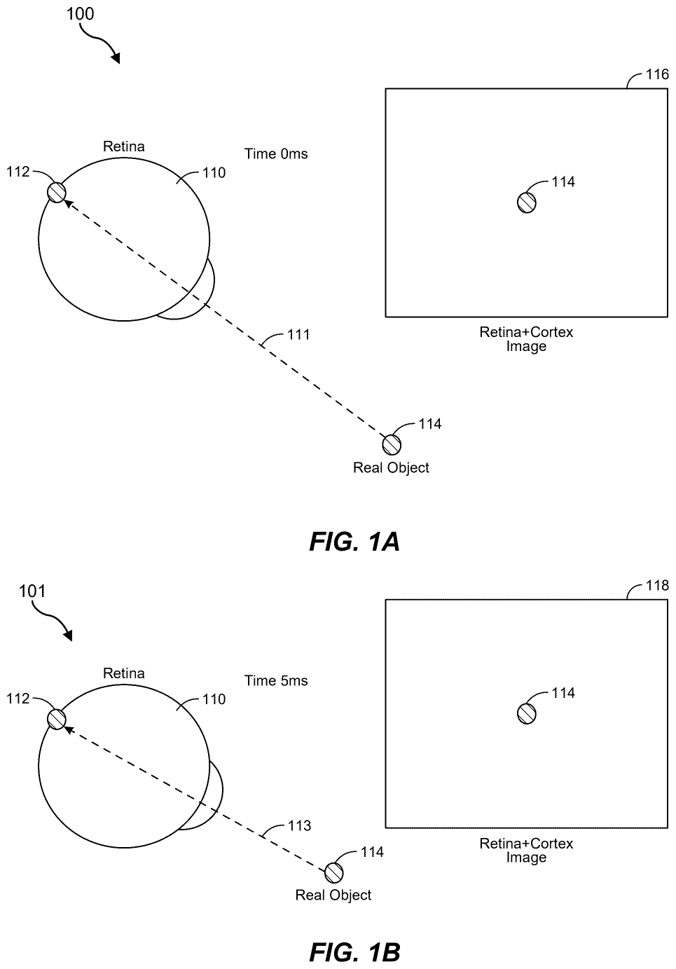

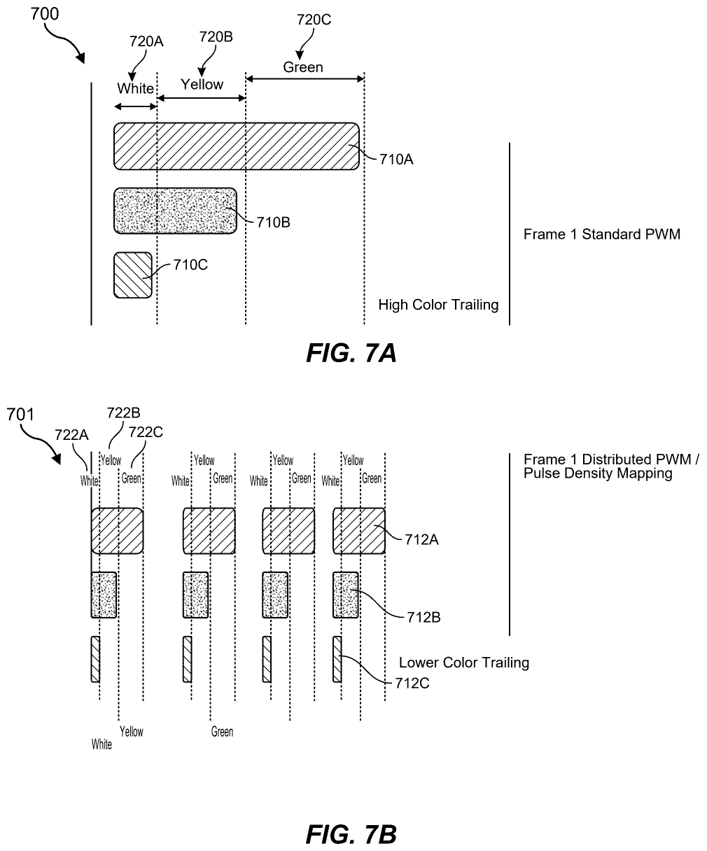

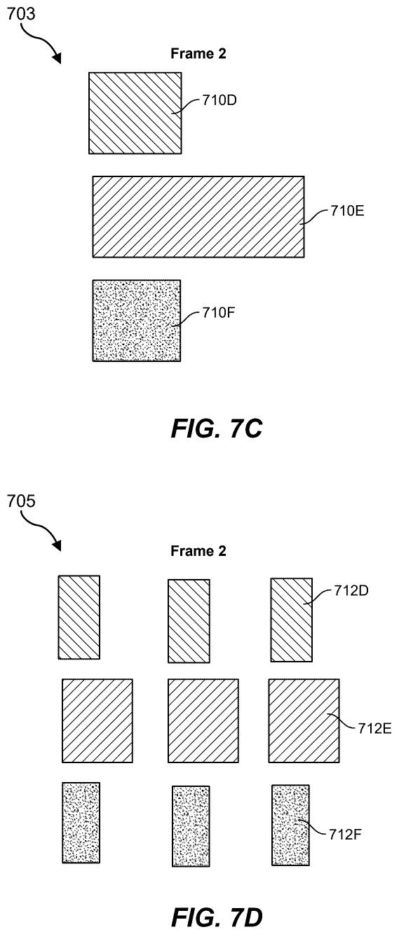

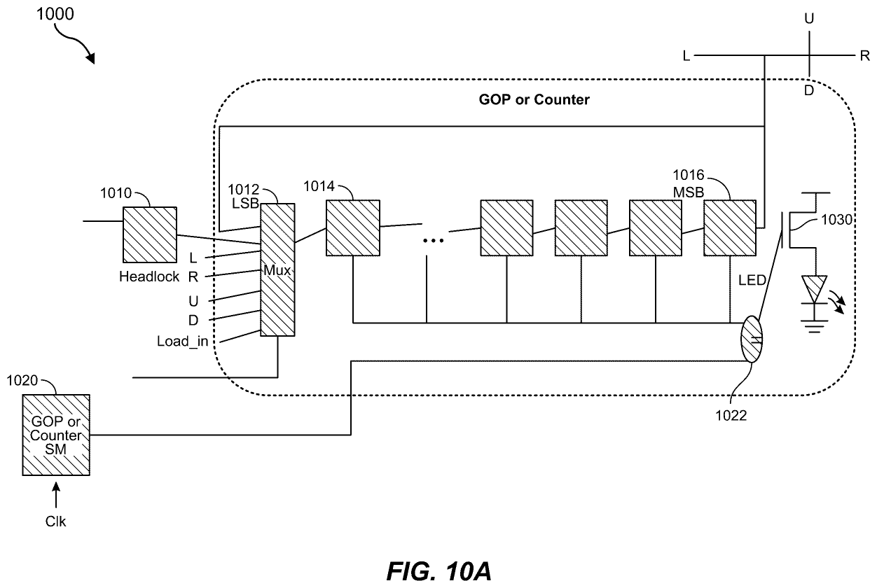

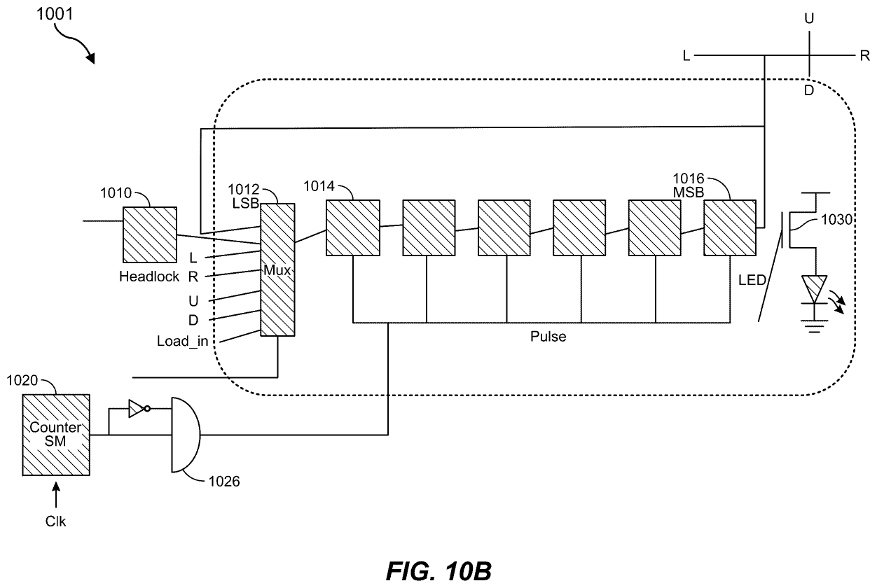

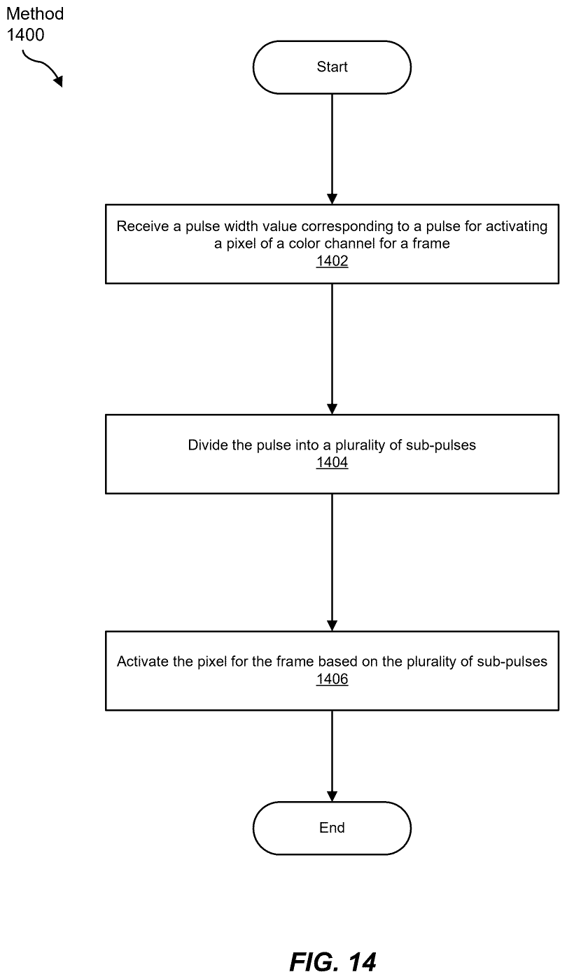

The following will provide, with reference to FIGS. 1-14, detailed descriptions of pulse density mapping that maintains color channel ratios. Detailed descriptions of visual artifacts will be provided in connection with FIGS. 1A-6C. Detailed descriptions of subdividing frames (into subframes or sub-pulses) will be provided in connection with FIGS. 7A-9, 11A-11B, and example circuits for the subdividing will be provided in connection with FIGS. 10A-10B, 12, and 13. In addition, detailed descriptions of an example process for pulse density mapping with color channel ratios will be provided in connection with FIG. 14.

FIG. 1A illustrates a diagram 100 of a retina 112 of a user's eye 110 viewing a real object 114 in the real world. As illustrated in FIG. 1A, real object 114 may be centered in a cortex image 116. FIG. 1B illustrates a diagram 101 showing how when the head (e.g., eye 110 and retina 112) move with respect to real object 114 (e.g., the head moves and/or the object moves), which may correspond to 5 ms elapsing, eye 110 may remain centered on real object 114 (e.g., the eye may automatically track the real object), as reflected in cortex image 116. Eye 110 may move such that real object 114 may remain generally centered with respect to retina 112 (e.g., as illustrated with cortex image 116 and cortex image 118 keeping real object 114 relatively centered after the movement). An eye axis 111 in FIG. 1A as compared to an eye axis 113 in FIG. 1B further illustrates a movement of eye 110 with respect to the changed position of real object 114 to maintain the centered cortex images.

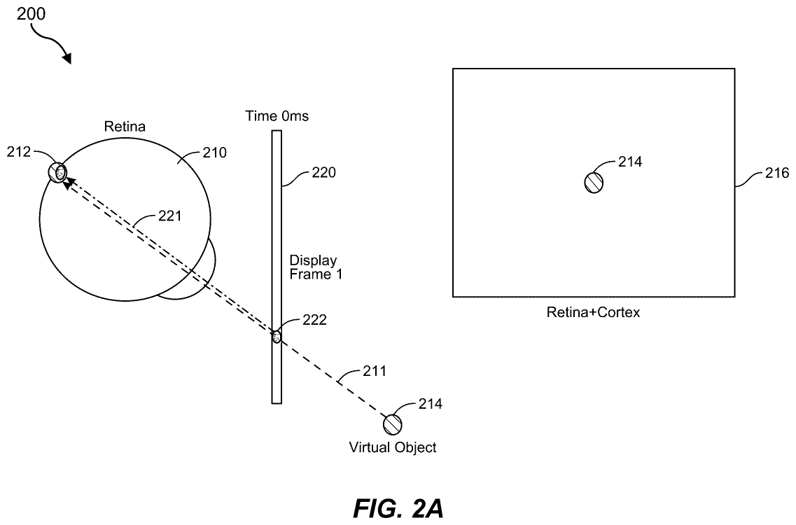

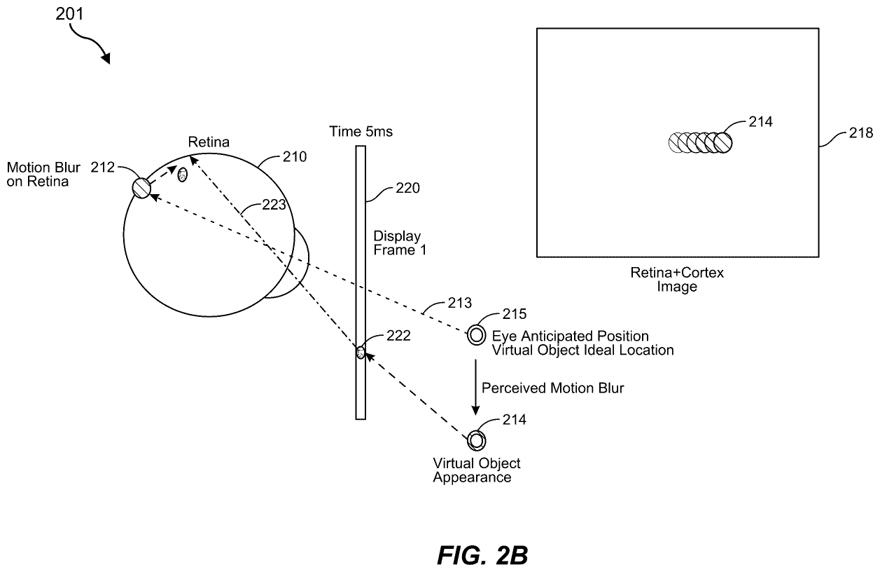

FIGS. 2A and 2B illustrate a scenario analogous FIGS. 1A and 1B, respectively, for when the user is viewing a virtual object 214 with a display 220. Diagram 200 in FIG. 2A illustrates a retina 212 of an eye 210 viewing a pixel 222 of display 220 (e.g., a frame displayed on display 220) corresponding to virtual object 214. However, display 220 and pixel 222 themselves may physically remain stationary with respect to eye 210. An eye axis 211 between eye 210 and virtual object 214 may coincide with a virtual axis 221 between eye 210 and pixel 222 representing virtual object 214.

A diagram 201 in FIG. 2B illustrates virtual object 214 moving to an anticipated virtual location 215 (similar to real object 114 in FIG. 1B). Also similar to FIG. 1B, eye 210 may move in anticipation, to keep the cortex image centered (e.g., illustrated by an eye axis 213 between eye 210 and virtual location 215 being similar to eye axis 113). However, this may create an eye axis 223 between eye 210 and pixel 222 that is no longer aligned with eye axis 223. Further, eye 210 having to focus on a different pixel rather than tracking the original pixel (e.g., pixel 222) may result in perceived motion blur, as illustrated in a cortex image 218.

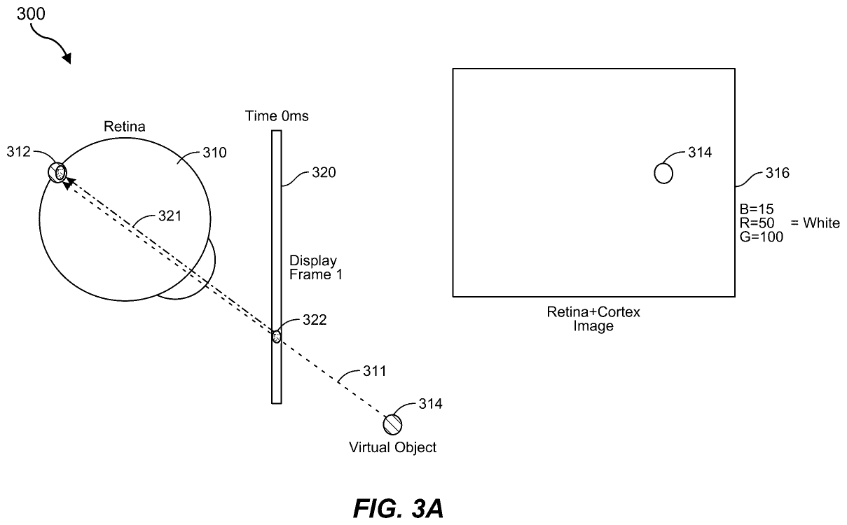

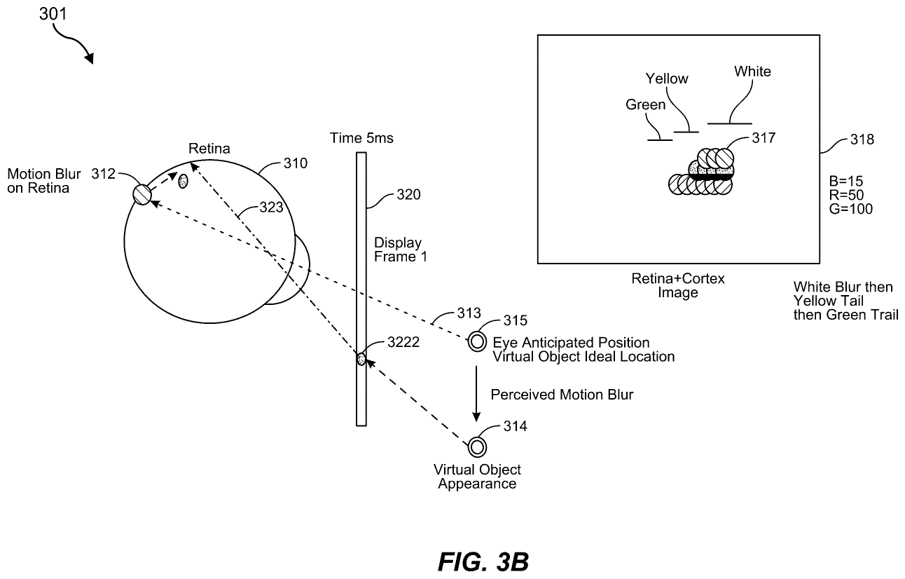

Moreover, FIGS. 2A and 2B may correspond to a single-color channel. When incorporating multiple color channels (e.g., RGB), the eye may experience additional visual artifacts. FIGS. 3A and 3B illustrate diagrams 300 and 301, respectively, analogous to FIGS. 2A and 2B, respectively, with the addition of multiple color channels (e.g., each display pixel corresponding to 3 pixels, one for each color channel), for when the user is viewing a virtual object 314 with a display 320. Diagram 300 in FIG. 3A illustrates a retina 312 of an eye 310 viewing a pixel 322 (e.g., including subpixels for the multiple color channels) of display 320 (e.g., a frame displayed on display 320) corresponding to virtual object 314. As described above, display 320 and pixel 322 themselves may physically remain stationary with respect to eye 310. An eye axis 311 between eye 310 and virtual object 314 may coincide with a virtual axis 321 between eye 310 and pixel 322 representing virtual object 314. In addition, pixel 322 may produce different colors via pulse width modulation (PWM). A desired color may be produced by controlling each color channel (e.g., corresponding subpixel) with a pulse width corresponding to an on period (e.g., 100% brightness for the pixel for the color channel) and an off period (e.g., 0% brightness) to achieve desired colors. Combining different pulse widths for the different color channels may accordingly achieve desired colors. For example, if a given frame is divided into subframes (e.g., smaller portions of time within a total time for a frame), which may be designated by any appropriate unit/measurement (e.g., time such as ms, ns, etc., fraction/percent with respect to a full frame, clock/processor cycles, etc.), the pulse widths may be defined relative to subframes (e.g., a number of subframes for an on period). In one example, pixel 322 may display a color that includes 15 subframes for a blue channel, 50 subframes from a red channel, and 100 subframes for a green channel.

A diagram 301 in FIG. 3B illustrates virtual object 314 moving to an anticipated virtual location 315 (similar to virtual object 214 in FIG. 2B). Also similar to FIG. 2B, eye 310 may move in anticipation, to keep the cortex image centered (e.g., illustrated by an eye axis 313 between eye 310 and virtual location 315 being similar to eye axis 213). Similar to FIG. 2B, this may create an eye axis 323 between eye 310 and pixel 322 that is no longer aligned with eye axis 323. Further, eye 310 having to focus on a different pixel rather than tracking the original pixel (e.g., pixel 222) may result in perceived motion blur, as illustrated in a cortex image 318.

However, with different pulse widths for the different color channels for a given pixel, there may be periods of time in which one or more color channels are off, momentarily producing a different color that combined with motion blur as described above, may produce different color trails. For example, during the first 15 subframes, all three color channels may be on, creating a white blur (e.g., due to all three colors combining into white). After the 15 subframes, the blue channel may be off, such that during the next 35 subframes (e.g., until the red channel is off), a yellow tail (due to green and red being on together to form yellow) may be seen. Finally, after 50 subframes, the red channel may be off, such that during the remaining 50 subframes a green tail may be seen (due to only green being on). Depending on eye movement timing with respect to the subframes, such blurs/tails may be noticeable.

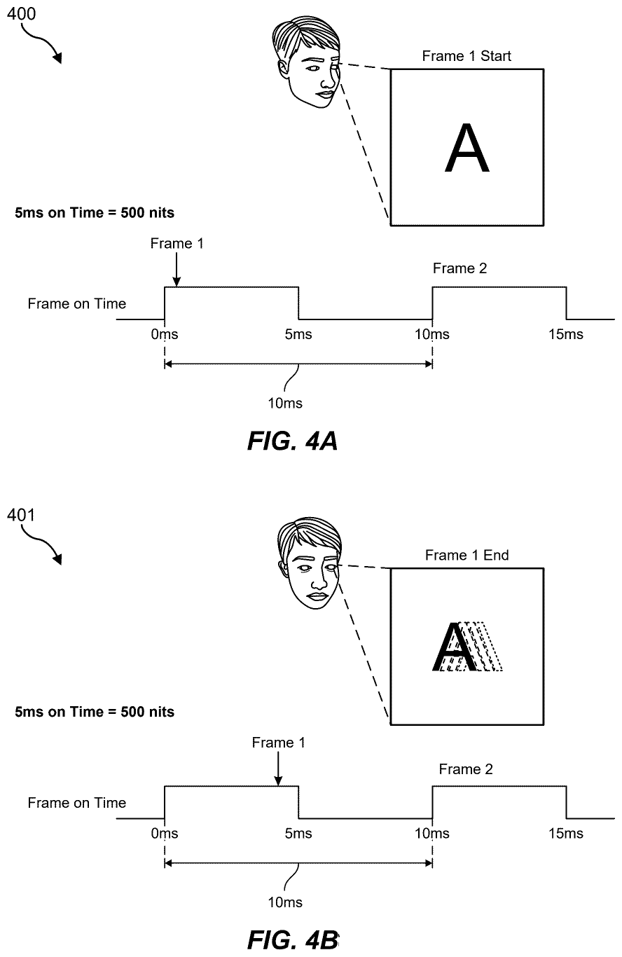

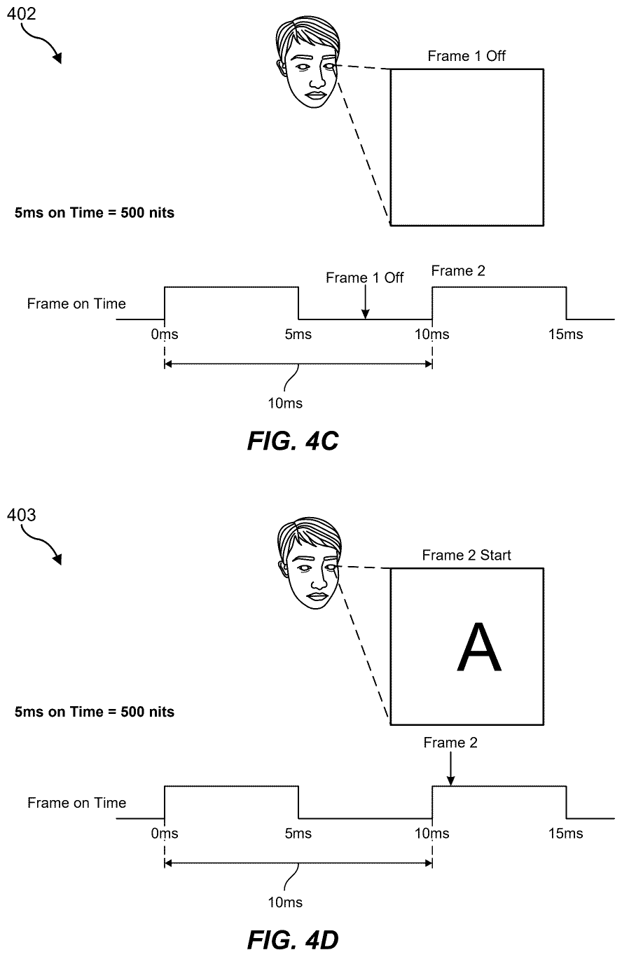

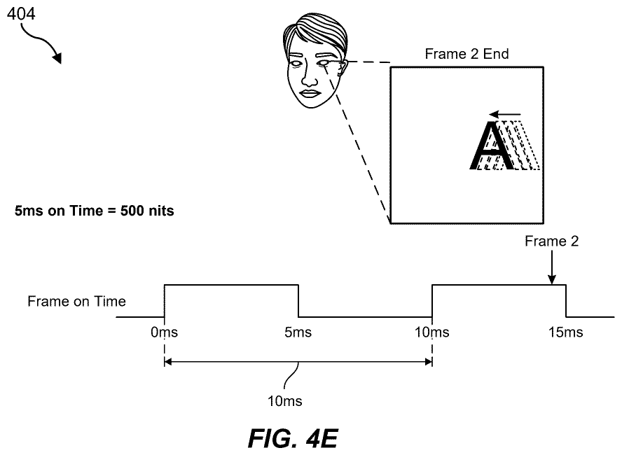

FIGS. 4A-4G illustrate diagrams of a user viewing example frames (e.g., one or more pixels thereof) exhibiting visual artifacts. FIG. 4A illustrates a diagram 400, depicting the user viewing an image for frame 1. Frame 1 may have an on time (e.g., having pixels on at 500 nits) of 5 ms, and an off time of 5 ms for a total frame time of 10 ms. FIG. 4A illustrates the user viewing a start of frame 1, and more specifically, a start of the on time.

FIG. 4B illustrates a diagram 401, depicting the user moving (e.g., the user's head and/or eyes moving), during the on time of frame 1, exhibiting a blur in the image. The movement may be occurring near a middle or end of the on time for frame 1. FIG. 4C illustrates a diagram 4002, during the off time of frame 1, in which the user may not see the image. The user may also continue to move.

FIG. 4D illustrates a diagram 403, during an on time of frame 2, in which the user may see the image. FIG. 4E illustrates a diagram 404, during the on time of frame 2, in which the user may be moving, seeing a blur in the image.

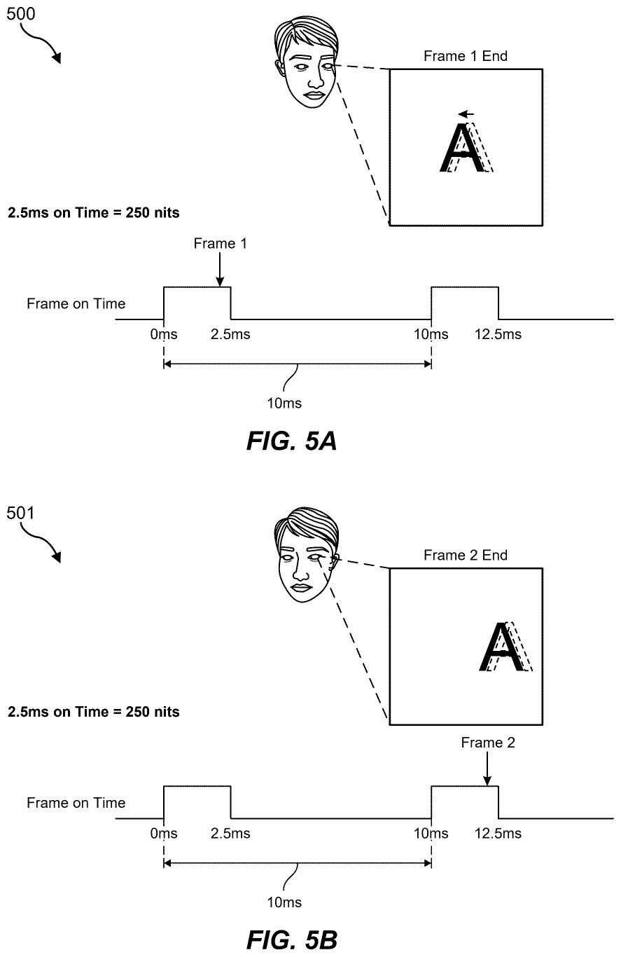

FIG. 5A illustrates a diagram 501 of a frame 1 having on time of 2.5 ms (and an off time of 7.5 ms for a total frame time of 10 ms). A user may see a lesser blur in the image near the end of the on time, which may be near a beginning of the total frame time. FIG. 5B illustrates a diagram 501, in which the user may also see the lesser blur at the end of the on time for a frame 2 (having a similar on/off time).

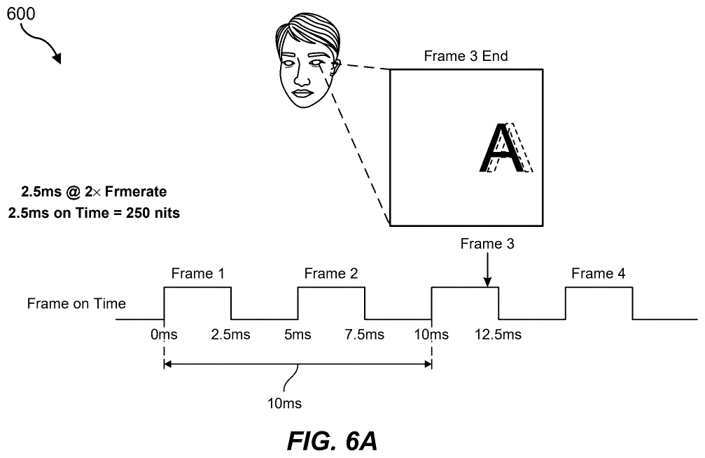

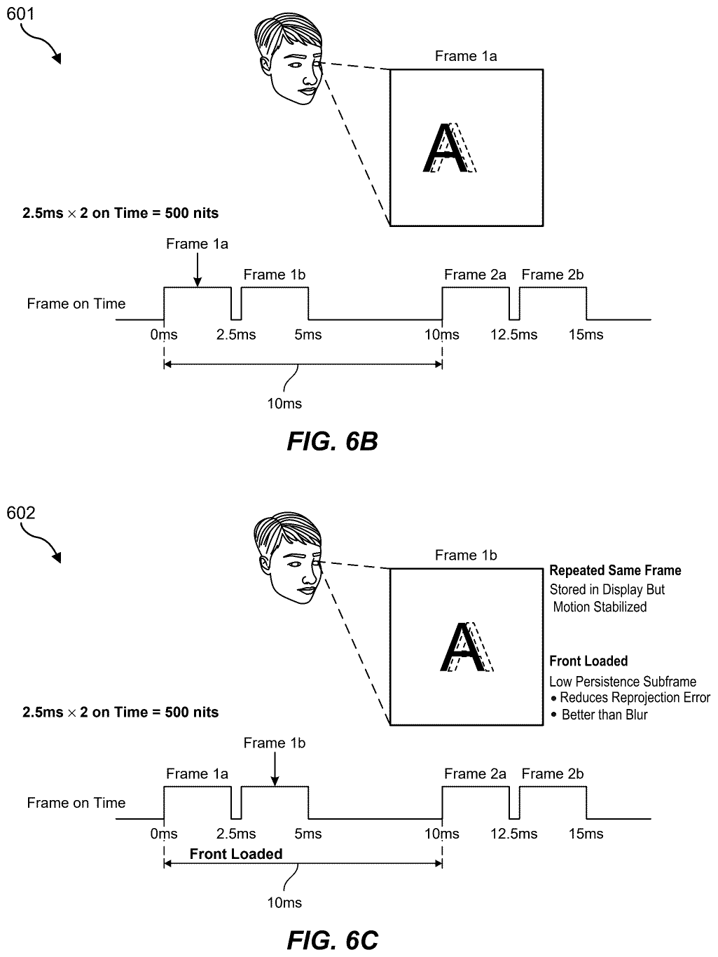

FIG. 6A-6C illustrate diagrams of example viewing of frames exhibiting visual artifacts. FIG. 6A illustrates a diagram 600, which may be an example of a 2× framerate (e.g., 2 subframes) compared to FIGS. 4A-4E and 5A-5B, in which each frame may have a 2.5 ms on time in a 10 ms span for both frames. At the end of the on time for a frame 3, the user may see a lesser blur (e.g., similar to FIG. 5A as compared to FIG. 4B).

FIG. 6B illustrates a diagram 601, with each frame having a 5 ms on time (e.g., similar to FIGS. 4A-4E). However, in FIG. 6B, the 5 ms on time may be subdivided into two 2.5 ms subframes (e.g., frame 1a and frame 1b representing the same subframe). The user may see a lesser blur in the middle of frame 1a (e.g., similar to FIG. 5A as compared to FIG. 4B). FIG. 6C illustrates a diagram 602, in which the same frame/subframe may be repeated, such that in the middle of frame 1b, a similar blur may be seen (e.g., as in FIG. 6B). Repeating the same subframe in a front loaded fashion (e.g., as the beginning of the 10 ms span, as illustrated in FIGS. 6B and 6C), may result in stabilized motion, reducing reprojection error and improving upon the blur. In some examples, the same frame may be stored in the display (e.g., in a memory of the display). In other words, a low persistence subframe may reduce blurs or otherwise stabilize motion as compared to a full contiguous frame (e.g., FIGS. 4A-4E). The frame on times may be considered a pulse (e.g., using PWM). The subdivision of frames will be described further with respect to FIGS. 7A-7D.

FIG. 7A illustrates a frame 700 further illustrating PWM for a given frame creating color trailing. FIG. 7A represents a similar color as the example described above (e.g., B=15, R=50, and G=100) with segment widths corresponding to the channels (not to scale). A channel pulse 710A may correspond to a first color channel (e.g., green), a channel pulse 710B may correspond to a second color channel (e.g., red), and a channel pulse 710C may correspond to a third color channel (e.g., blue). FIG. 7A may generally represent time going from left to right (e.g., from a start of a frame to an end of the frame) such that a first period 720A may correspond to a subframes when all three color channels are on (e.g., a duration of channel pulse 710C). First period 720A may produce a white light. A second period 720B may correspond to subframes after channel pulse 710C ends up until channel pulse 710B ends. Second period 720B may produce a yellow light, as the blue channel is off and the red and green channels are on. A third period 720C may correspond to subframes after channel pulse 710B ends up until channel pulse 710A ends. Third period 720C may produce a green light, as both blue and red channels are off and only green channel is on. In other words, the pulses may start at the same time, yet end at different times, with the various periods being long enough to be observable by a human eye, exhibiting color trailing.

FIG. 7B illustrates a frame 701 corresponding to frame 700 with pulse density mapping. Using pulse density mapping, the pulses may be divided into sub-pulses and more evenly distributed throughout the subframes of the frame, resulting in multiple shorter periods rather than longer contiguous periods of the different colors. This may result in reduced color trailing. For example, multiple channel sub-pulses 712A (corresponding to the first color channel) may in aggregate equal channel pulse 710A. Similarly, multiple channel sub-pulses 712B (corresponding to the second color channel) may in aggregate equal channel pulse 710B, and multiple channel sub-pulses 712C (corresponding to the third color channel) may in aggregate equal channel pulse 710C.

As further illustrated in FIG. 7B, the pulses may be subdivided. A first period 722A may correspond to a start of a given subdivision of pulses up until channel sub-pulse 712C ends for the given subdivision, a second period 722B may correspond to the end of channel sub-pulse 712C to the end of channel sub-pulse 712B for the given subdivision, and a third period 722C may correspond to the end of channel sub-pulse 712B to the end of channel sub-pulse 712A. Although these periods in aggregate may equal those of FIG. 7A, because the periods themselves may be shorter due to the subdivisions, the color trailing effect may be less noticeable to the human eye.

Moreover, the subdivisions may maintain a ratio of pulse widths between the color channels in order to produce the same desired color. FIGS. 7C and 7D illustrate another example of pulse density mapping. FIG. 7C illustrates a frame 703 including a channel pulse 710D (corresponding to a first color channel), a channel pulse 710E (corresponding to a second color channel), and a channel pulse 710F (corresponding to a third color channel). FIG. 7D illustrates a frame 705 corresponding to frame 703 with pulse density mapping with three subdivisions, although in other examples any other number of subdivisions may be used. The first color channel may include a channel sub-pulse 712D (corresponding to the first color channel) for each subdivision, a channel sub-pulse 712E (corresponding to the second color channel) for each subdivision, and a channel sub-pulse 712F (corresponding to the third color channel) for each subdivision. As illustrated in FIG. 7D, a ratio of sub-pulse widths between the color channels for each subdivision may be the same as a ratio of pulse widths between the color channels for frame 703. In other words, each subdivision may include a scaled down version (e.g., scaled based on number of subdivisions) of the frame (e.g., frame 703).

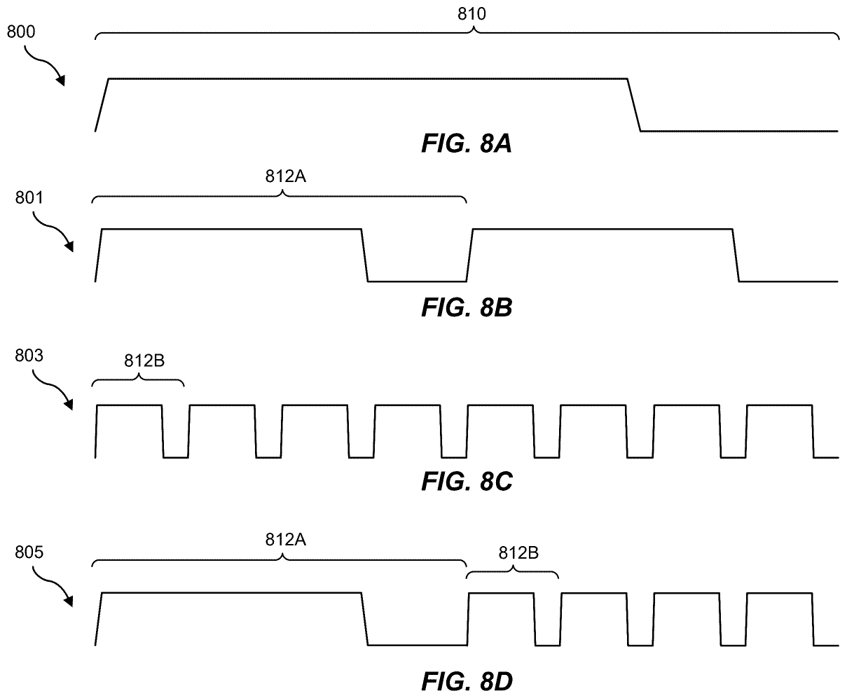

FIGS. 8A-8D illustrates a diagram 800, a diagram 801, a diagram 803, and a diagram 805, respectively, of timeline comparisons of pulses, including a pulse 810 (corresponding to any of channel pulses 710A-F), a sub-pulse 812A and a sub-pulse 812B (corresponding to respective instances of any of channel sub-pulses 712A-F), according to different example pulse density mapping schemes, as will be described further below. The pulses may generally illustrate (not to any particular scale) voltage and/or logical high-low values, further indicating when the corresponding pixel/sub-pixel is on or off, and further representing a single color channel. FIG. 8A illustrates pulse 810 representing a lowest distribution (e.g., 1 subdivision), which may be similar to a pulse width modulation (PWM) scheme, in which the total pulse width may be consolidated into one continuous pulse. As described above, this scheme may produce undesirable visual artifacts.

FIG. 8B illustrates sub-pulse 812A representing a partial distribution in which the pulses may be divided into subframes, each subframe maintaining a duty cycle similar to the full frame (e.g., pulse 810). More specifically, the middle graph may correspond to two subframes, such that sub-pulse 812A represents a scaled down (e.g., ½×) version of pulse 810 that is repeated a corresponding number of times (e.g., 2× for having scaled down ½×) to achieve the same duty cycle of pulse 810.

FIG. 8C illustrates a full distribution in which the subframes may be at/near a smallest feasible size, yet still maintaining the duty cycle (e.g., smaller and more numerous subframes). Sub-pulse 812B represents a further scaled down (e.g., ⅛× although other scalings may be used) version of pulse 810 that is also repeated a corresponding number of times (e.g., 8× for having scaled down ⅛×) to achieve the same duty cycle of pulse 810. In other words, a scale factor may be the same as a repetition factor.

Moreover, the subframes may include unequally scaled sub-pulses (e.g., an unequal or uneven distribution). FIG. 8D illustrates out differently scaled sub-pulses may be used to collectively achieve the same duty cycle of pulse 810. For example, one sub-pulse 812A and four sub-pulses 812B may achieve the same duty cycle of pulse 810. In other examples, other combinations of sub-pulses scalings and repetitions may be used, including different sequences (e.g., interleaving larger and smaller sub-pulses, etc.).

Although a distribution closer to the full distribution may be desired for reducing visual artifacts, in some examples, the full distribution may consume more power (as compared to PWM) due to numerous short pulses between on and off (e.g., a high frequency of pulse switches and/or short duration between pulse switches). For example, the frequency of pulse switches for a distribution may be compared to a frequency threshold (which may be based on or otherwise represent power consumption) such that the frequency of pulse switches for a selected distribution may not exceed the frequency threshold (e.g., establishing an upper and/or lower limit to a number of subdivisions or scaling). Further a duration threshold of a given frequency may relate to power consumption, such that uneven distributions as described herein may be compared to the frequency threshold (e.g., comparing segments of the uneven distribution to the duration threshold, which may include comparing a shortest pulse width to a pulse width threshold). In yet other examples, the ratios of pulse widths between the channels may also be considered. For example, a large ratio between channels may indicate a large difference in pulse widths, such that certain distributions that are favorable for one channel may be unfavorable for another channel. The ratios of pulse widths between the channels may be compared against a threshold ratio of pulse widths between the channels to establish an upper and/or lower limit to a number of subdivisions or scaling. Moreover, in other examples, each channel may use different distributions (e.g., based on the thresholds just described). For example, if the ratio of pulse widths between the channels exceeds the threshold ratio, individual/independent distributions may be applied for each channel (e.g., applying frequency thresholds). In other examples, the channels may use the same distribution, which may be based on a most restricted channel, based on applying the thresholds described.

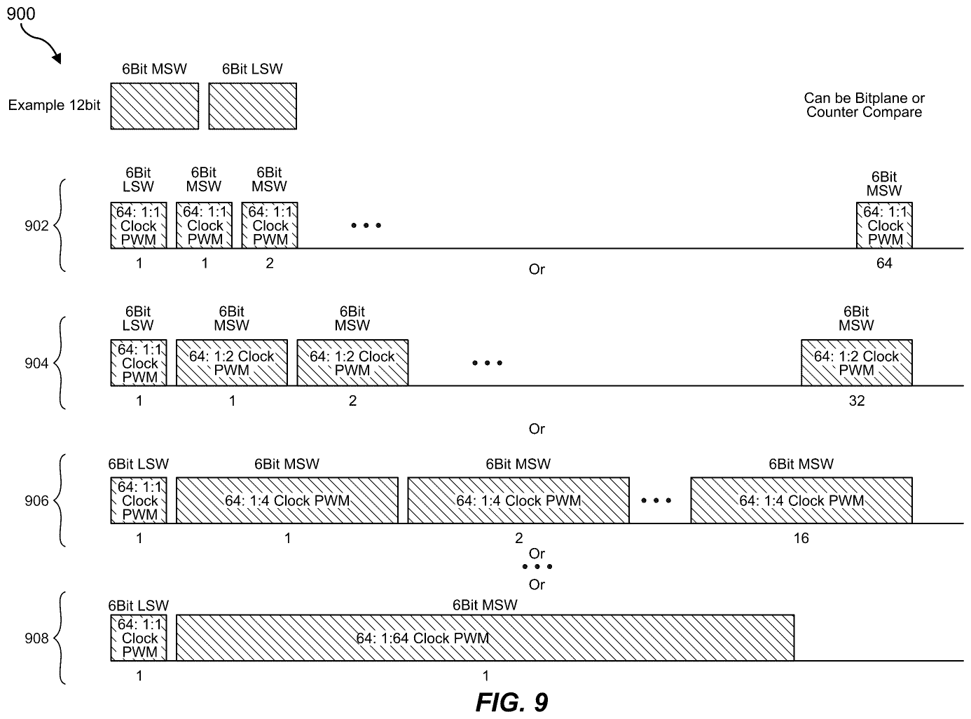

FIG. 9 illustrates a diagram 900 of an example bitplane-based pulse density mapping scheme for representing pulse widths with bit values. In a bitplane scheme, for a given value for a pixel/sub-pixel a least significant bit (LSB) of a value may represent a certain subframe time period (e.g., number of subframes/cycles) for a pulse width, also referred to as a sub-pulse herein, with “1” representing turning on the pixel/sub-pixel for that number of subframes/cycles (e.g., an active period sub-pulse), and “0” turning off the pixel/sub-pixel for that number of subframes/cycles (e.g., an inactive period sub-pulse). Progressing to the most significant bit (MSB), each successive bit value may represent and exponentially longer (e.g., 2×) subframe time period. In one example, using a 12-bit value, the upper 6 MSBs may form a most significant word (MSW) and the lower 6 LSBs may for a least significant word (LSW). Based on the 6 bits (and 2× exponential growth) the MSW may represent 64× length of the LSW.

In one implementation, the LSW may map to a block of 64 cycles (or subframes or other appropriate division of a frame) with the LSB representing a single cycle (the second LSB representing 2 cycles, the third LSB representing 4 cycles, and so forth), which when summing all 6 bits represents 64 total cycles. Thus, producing the sub-pulses from the LSW may involve applying the bits with a 1:1 clock (e.g., the bits representing cycles based on significance as just described). For example, a “1” value may represent pulsing on for the appropriate number of cycles based on bit significance, and similarly, a “0” value may represent off for the appropriate number of cycles based on bit significance.

Because the MSW represents 64× the time period of the LSW, the MSW may therefore map to 64 of such blocks. Thus, in one example, in a distribution 902, the MSW may be implemented by using the same 1:1 clock as with the LSW, and repeated (e.g., using the same MSW bits) the appropriate number of times (e.g., 64). This example may represent a more distributed scheme, illustrated by distribution 902 in FIG. 9, in which the MSW bits may be iterated through 64×. Each block may represent a subframe. In some implementations, distribution 902 may represent a most distributed scheme.

In some examples, modifying the distribution (e.g., number of subdivisions or scaling) may involve modifying a clock ratio, as compared to the LSW. For example, a distribution 904 may use a 1:2 clock, in which each MSW bit represents 2× the cycles based on bit significance (e.g., the LSB representing 2 cycles, the second LSB representing 4 cycles, and so forth), each MSW subframe may accordingly be 2× the width of a MSW subframe in distribution 902. Accordingly, using the 1:2 clock, the MSW may be repeated an appropriately scaled number of times (e.g., 32× as the 32× at 1:2 clock may equal the 64× at 1:1 clock). Distribution 904 may be less distributed (and more coalesced into bigger subframes) than distribution 902. In other words, increasing the clock ratio (e.g., increasing the scaling of how may cycles are represented by bits based on bit significance) may reduce distribution or increase subframe sizes as well as reduce a number of times of iterating through the MSW bits.

In another example, a distribution 906 may use a 1:4 clock, such that the MSW bits represent 4× the cycles as the 1:1 clock (e.g., the LSB representing 4 cycles, the second LSB representing 8 cycles, and so forth). Accordingly, the MSW subframes may be repeated 16× (e.g., 16× at 1:4 clock equaling 64× at 1:1 clock).

In yet another example, a distribution 908 may use a 1:64 clock, such that the MSW bits represent 64× the cycles as the 1:1 clock (e.g., the LSB representing 64 cycles, the second LSB representing 128 cycles, and so forth). Accordingly, there is one MSW subframe. In some implementations (e.g., for a 12 bit scheme as illustrated in FIG. 9), distribution 908 may correspond to a least distributed scheme (e.g., a single MSW subframe achieving the entire 64× cycles) which may further correspond to a PWM scheme. FIG. 9 illustrates examples of subframes of more or less distributed schemes may be achieved via clock scaling. Further, although FIG. 9 illustrates a uniform clock ratio applied for each distribution, in other examples, the clock ratio may be non-uniform for subframes while still achieving the necessary MSW cycles. For example, the 64×MSW cycles may be achieved using a combination of 16 MSW subframes at 1:2 with 8 MSW subframes at 1:4, or a combination of 16 MSW subframes at 1:1 with 12 MSW subframes at 1:2 and 6 MSW subframes at 1:4, etc.

FIG. 10A illustrates an architecture 1000 of an example counter circuit implementation. FIG. 10A includes an input circuit 1010 for providing an input signal (e.g., a bit value or word), a controller circuit 1012 for managing signals and neighboring pixels, a pixel circuit 1030 (e.g., an LED circuit or other circuit for a pixel or subpixel), a series of bit circuits (e.g., flip flop circuits or other data element circuits) including an LSB circuit 1014 and an MSB circuit 1016, a counter control circuit 1020 and a counter output circuit 1022. In some examples, counter control circuit 1020 and counter output circuit 1022 may generally represent a counter circuit. The counter circuit may use a clock signal (e.g., defining cycles via rising and falling voltages) to control pulse timings. Further, input circuit 1010, controller circuit 1012, counter control circuit 1020, and/or counter output circuit 1022 may generally represent a control circuit for pixel circuit 1030 and/or the series of bit circuits.

As a word (e.g., LSW and/or MSW as described above), is propagated from input circuit 1010, to controller circuit 1012, and through the series of bit circuits (e.g., serially shifting out values from LSB circuit 1014 to MSB circuit 1016), pixel circuit 1030 may accordingly activate (e.g., for on pulses) and deactivate (e.g., off pulses) based on the values in the bit circuits as well as the position within the series of bit circuits (representing bit significance). For a given word, each iteration through the series of bit circuits may increment the counter, such that the word may repeat iterating through the series of bit circuits until the counter reaches the appropriate counter threshold value, which may be based on distribution as described with respect to FIG. 9. For example, an LSW may iterate through once (e.g., counter threshold value of 1), whereas an MSW may iterate through multiple times (e.g., counter threshold value of 64 or other appropriate value as described above). In some examples, the counter circuit may include predetermined values, such as the counter threshold value(s), clock ratio value(s), etc. which may also be selectable. In some examples, the counter circuit may dynamically determine the values, such as the counter threshold value(s), clock ratio value(s), etc., such as from analyzing or otherwise observing the bit values, receiving a control signal or additional data, etc.

FIG. 10B illustrates an architecture 1001 of another example counter circuit implementation. The counter circuit may be represented by counter control circuit 1020 and counter output circuit 1026, which in some examples may increase a number of cycles that bit values are stored (e.g., before shifting out) in the series of bit circuits. Further, input circuit 1010, controller circuit 1012, counter control circuit 1020, and/or counter output circuit 1026 may generally represent a control circuit for pixel circuit 1030 and/or the series of bit circuits.

In some examples, the pulse density mapping described herein may apply to moving image pixels. For example, as a user's head and/or eyes move (e.g., as detected by an IMU, accelerometer, or other motion detector), an image (e.g., of a virtual object) may need to move to a different part of the display to maintain the same virtual object location with respect to the user's eyes (see, for example, FIGS. 2A-2B and 3A-3B), even if the image itself is otherwise static. In other words, a color presented by a physical pixel of the display, may need to move to a neighboring physical pixel of the display. Other examples of image movement may include the virtual object itself moving to a different virtual location or otherwise moving/changing, and other changes in the displayed image.

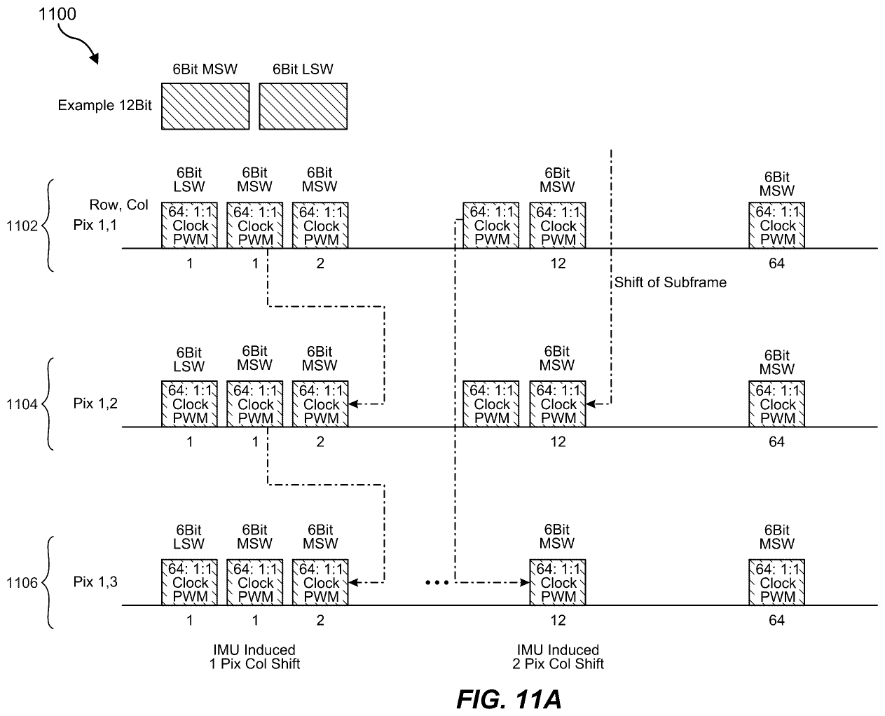

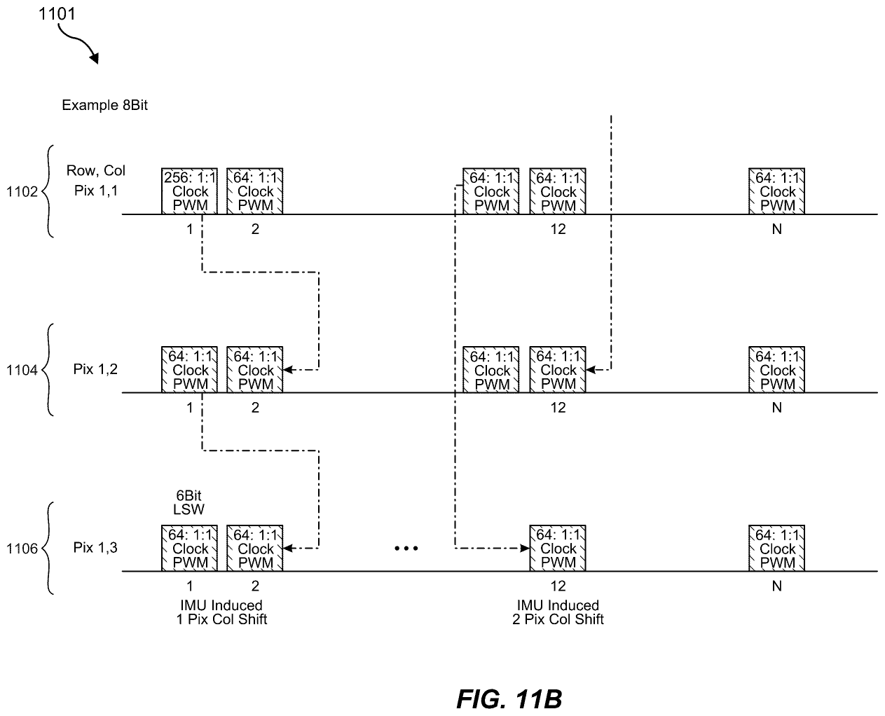

It may be desirable to update pixels with new color values without waiting until the end of a given frame, such as for movement occurring/continuing mid-frame. FIGS. 11A-11B illustrate examples of pixel shifting with pulse density mapping. FIG. 11A illustrates a diagram 1100 of pulse density mapping with pixel shifting for a 12 bit value (e.g., a 6 bit MSW and 6 bit LSW as described with respect to FIG. 9). FIG. 11A may correspond to a highly distributed scheme (e.g., similar to distribution 902 in FIG. 9), which may correspond to a most distributed scheme, having the MSW subframes being similar number of cycles as the LSW subframe, and repeated an appropriate number of times. In other examples, other distributions and/or combinations of distributions may be used, as described herein.

FIG. 11A further illustrates multiple pixels (e.g., as opposed to FIG. 9 representing a single pixel/sub-pixel), which may include a pixel 1102, a pixel 1104, and a pixel 1106. Although referred to as pixels, in some implementations these pixels may represent subpixels of a same color channel. FIG. 11A further illustrates an example of pixels being in a same row, such as pixel 1102 being in row 1, column 1, pixel 1104 being in row 1, column 2, and pixel 1106 being in row 1, column 3, to illustrate movement across a row, although in other examples, the movement may move across the row in either direction, and/or along a column in either direction.

In FIG. 11A, after the first MSW subframe, a pixel shift may occur, by sending the current MSW bits to the appropriate neighboring pixel, as illustrated. In some examples, pixel 1102 (which may represent a display edge) may receive a new pixel value (e.g., a newly generated bit value and/or MSW) or may continue with the current MSW. The new pixel value may be used to derive subframes for a remainder of the frame, or until another pixel value is provided (e.g., shifted from a neighbor). Another shift of subframe may occur for subframe 12, with each pixel sending the current MSW (which was previously provided by a neighboring pixel) to the appropriate neighboring pixel. Thus, FIG. 11A illustrates a 2 pixel column shift, such that the original MSW for pixel 1102 has been propagated to pixel 1106. In other examples, the shifts may occur in any appropriate direction (e.g., up, down, left, right, with respect to a pixel array/grid), which may also include a pixel receiving its original MSW.

FIG. 11B illustrates a diagram 1101 of pulse density mapping with pixel shifting for an 8 bit value. The 8 bit value may not be broken into small words, such that the bits may represent 256 cycles (e.g., the LSB representing 1 cycle, the second LSB representing 2 cycles, and so forth). FIG. 11B also illustrates a 2-pixel column shift, similar to FIG. 11A. In FIG. 11B, with the original bit value not being broken into words, the whole bit value may instead be propagated. In other examples, other bit sizes may be used as well as other combinations of bit sizes and divisions into words.

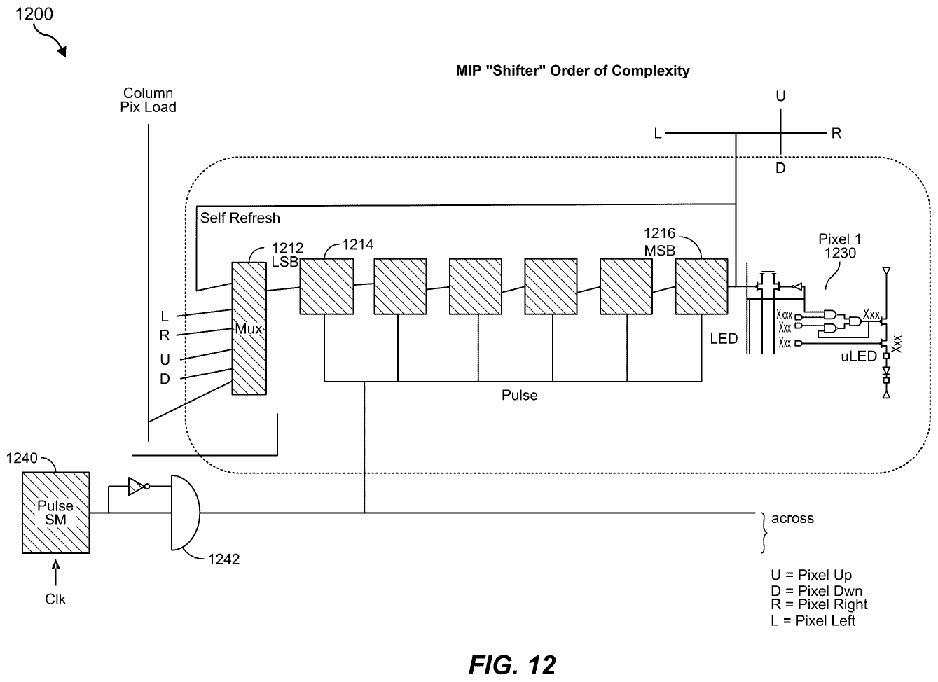

FIG. 12 illustrates an example architecture 1200 of a shifter circuit implementation. FIG. 12 includes a controller circuit 1212 (corresponding to controller circuit 1012) for managing signals and neighboring pixels, a pixel circuit 1230 (corresponding to pixel circuit 1030), a series of bit circuits including an LSB circuit 1214 (corresponding to LSB circuit 1014) and an MSB circuit 1216 (corresponding to MSB circuit 1016) which may act as a memory-in-pixel circuit, a pulse control circuit 1240, and a pulse output circuit 1244. In some examples, pulse control circuit 1240 and pulse output circuit 1242 may generally represent a pulse circuit. The pulse circuit may control, using a clock signal, the pulse timings, similar to the counter circuit described with respect to FIGS. 10A-10B. Further, an input circuit (e.g., similar to input circuit 1010), controller circuit 1212, pulse control circuit 1240, and/or pulse output circuit 1242 may generally represent a control circuit or shifter circuit for pixel circuit 1230 and/or the series of bit circuits.

Controller circuit 1212 may coordinate the pixel shifting described above with respect to FIGS. 11A-11B. In some examples, controller circuit 1212 may hold a current bit value for the respective pixel (e.g., pixel circuit 1230 by propagating the bit value through the bit circuits from LSB circuit 1214 to MSB circuit 1216). Based on control signals, controller circuit 1212 may forward the current bit value to the appropriate neighboring pixel (e.g., to the respective controller circuit 1212 of the neighboring pixel), which may be in a direction of up, down, left, or right, with respect to the pixel array.

In some examples, controller circuit 1212 may receive multiple bit values for a given frame (e.g., for multiple pixels such as a row, a column, and/or subdivision thereof). Controller circuit 1212 may receive control signals for directing the bit values, such as to LSB circuit 1214 (e.g., for pixel circuit 1230), such as directing the appropriate value to the appropriate pixel (e.g., the respective controller circuit 1212) to coordinate the pixel shifting.

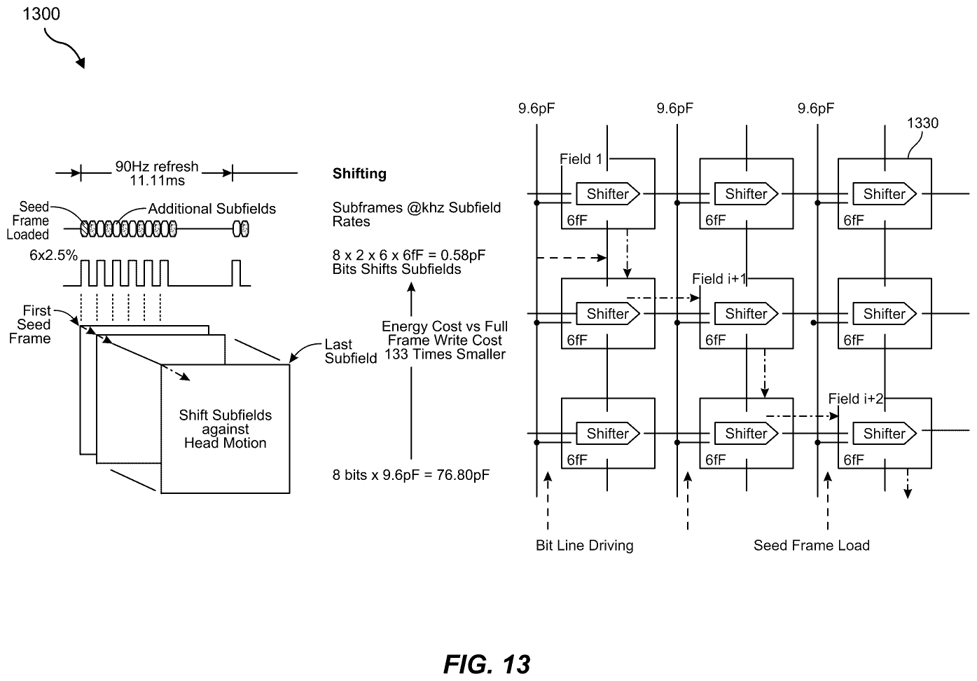

FIG. 13 illustrates a diagram 1300 of in-plane shifting (e.g., applying the pixel shifting described above to the rows and columns of a pixel array). A pixel array may include multiple iterations of a pixel circuit 1330 (corresponding to pixel circuit 1230 or any other pixel circuit described herein). As illustrated in FIG. 13, a subframe may shift in any direction needed across the pixel array, including a generally diagonal direction (e.g., down, right, down, right, etc.). In other words, pixel circuit 1330 may send its current subframe to any neighboring pixel circuit 1330 or no pixel circuit, and receive a subframe from any neighboring pixel circuit 1330 or not receive a subframe from a pixel circuit (e.g., using the current subframe and/or receiving new frame data). Moreover, in one example, a pixel may start with a seed frame (e.g., an initial subframe of the frame), and during successive subframe periods, receive different subframe values. In some example, this arrangement may provide power savings.

In some examples, the frame rate between the subframe in a single frame may be faster than the eye can saccade at ˜100 degrees/sec. The human eye may move 1 pixel over X seconds, indicating how much leeway the subframe may have for the right ratio. For instance, if 1 pixel=2 arcmins then the eye will move 6000 arcmin/sec such that 2 arcmins is 333 us of time, so every 333 us may correspond to the right ratio of RGB. Moreover, the difference in the value, in some examples, may not exceed 1 pixel motion.

FIG. 14 is a flow diagram of an exemplary method 1400 for display artifact mitigation using pulse density mapping. The steps shown in FIG. 14 may be performed by any suitable computer-executable code and/or computing system, including the system(s) illustrated in FIGS. 10A-10B, 12, and/or 13. In one example, each of the steps shown in FIG. 14 may represent an algorithm whose structure includes and/or is represented by multiple sub-steps, examples of which will be provided in greater detail below.

As illustrated in FIG. 14, at step 1402 one or more of the systems described herein may receive a pulse width value corresponding to a pulse for activating a pixel of a color channel for a frame. For example, one of the circuits described herein (e.g., as in FIGS. 10A-10B, 12, and/or 13) may receive the pulse width value. In some examples, the pulse width value corresponds to a bit sequence representing decreasing numbers of cycles from a most significant bit (MSB) of the bit sequence to a least significant bit (LSB) of the bit sequence (e.g., as described with respect to FIG. 9).

At step 1404 one or more of the systems described herein may divide the pulse into a plurality of sub-pulses. In some examples, dividing the pulse into the plurality of sub-pulses includes interleaving cycles represented by different bit values. For example, the division may be based on a selected distribution (e.g., one or more of the distributions as described with respect to FIG. 9 and implemented with a circuit as in in FIGS. 10A-10B, 12, and/or 13).

At step 1406 one or more of the systems described herein may activate the pixel for the frame based on the plurality of sub-pulses. For example, one of the circuits described herein (e.g., in FIGS. 10A-10B, 12, and/or 13) may activate the corresponding light source as described herein.

The systems described herein may perform step 1406 in a variety of ways. In one example, activating the pixel further comprises interleaving active periods corresponding to the plurality of sub-pulses with inactive periods (e.g., based on one or more of the distributions as described with respect to FIG. 9). In some examples, interleaving the cycles may include using a counter circuit (e.g., FIGS. 10A and/or 10B). In some examples, interleaving the cycles may include using a shifter circuit (e.g., FIGS. 12 and/or 13), for shifting subframes to neighboring pixels. Further, in some examples, step 1404 may be combined with step 1406 such that the dividing may occur as part of the process of activating the pixel.

In some examples, the steps described herein may be applied to multiple color channels (e.g., backplanes). For example, method 1400 may include receiving a second pulse width value corresponding to a second pulse for activating a second pixel of a second color channel for the frame, dividing the second pulse into a second plurality of sub-pulses, and activating the second pixel for the frame based on the second plurality of sub-pulses.

In some examples, a ratio between the pulse and the second pulse is maintained for the plurality of sub-pulses and the second plurality of sub-pulses. In some examples, dividing the pulse into the plurality of sub-pulses is based on the ratio satisfying a ratio threshold.

As detailed above, displays often use PWM to flash a pixel to mix the color or a backlight may use PWM to turn on an LED. The pulse timing (on time) of the LED (or uLED or miniLED) is based on the brightness, for instance producing a low brightness by having the LED on for a very short time compared to a high brightness keeping the LED on longer. Accordingly, PWM schemes keep the light source on continuously until the light source reaches its brightness count and then the light source is turned off. However, when mixing colors (e.g., using different light sources as different color channels) such a scheme may be problematic because the RGB light sources/LEDs may turn on together at the beginning of the frame, but colors with lower brightness for the mix will turn off and leave the brighter primary color on longer. If a user's eye is moving during the end of the frame, this brighter color may streak and cause problems such as color breakup and other issues. The same may be true for LCOS backlights because the R persistence may be different than that of the G or B channels. Even a single channel or monochrome frame may exhibit visual artifacts for similar reasons.

The present disclosure allows a different scheme within a frame for lighting up the frame. For example, in a single frame, light distribution may be proportional in the frame time with respect to the color channels. This scheme may maintain the ratio and split the overall time over the frame. Although pulse density mapping (PDM) may reference the splitting of the frame, the scheme described herein maintains the ratios, to avoid creating an artifact called false contouring. This cross correlation of the other colors improves PDM performance.

Further, in some implementations, the frame rate between a sub frame in the single frame should be faster than the eye can saccade at ˜100 deg/sec. The eye may move 1 pixel over X seconds, which may be used to determine subframe ratios. For example, if 1 pixel=2 arcmins, then the eye will move about 6000 arcmin/see, thus 2 arcmins is about 333 us of time such that every 333 us would be the right ratio of RGB. In other words, a difference in the value should not exceed 1 pixel of motion.

### EXAMPLE EMBODIMENTS

Example 1. A method comprising: receiving a pulse width value corresponding to a pulse for activating a pixel of a color channel for a frame; dividing the pulse into a plurality of sub-pulses; and activating the pixel for the frame based on the plurality of sub-pulses.

Example 2. The method of Example 1, wherein activating the pixel further comprises interleaving active periods corresponding to the plurality of sub-pulses with inactive periods.

Example 3. The method of Example 1 or 2, further comprising: receiving a second pulse width value corresponding to a second pulse for activating a second pixel of a second color channel for the frame; dividing the second pulse into a second plurality of sub-pulses; and activating the second pixel for the frame based on the second plurality of sub-pulses.

Example 4. The method of Example 3, wherein a ratio between the pulse and the second pulse is maintained for the plurality of sub-pulses and the second plurality of sub-pulses.

Example 5. The method of Example 4, wherein dividing the pulse into the plurality of sub-pulses is based on the ratio satisfying a ratio threshold.

Example 6. The method of any of Examples 1-5, wherein the pulse width value corresponds to a bit sequence representing decreasing numbers of cycles from a most significant bit (MSB) of the bit sequence to a least significant bit (LSB) of the bit sequence.

Example 7. The method of Example 6, wherein dividing the pulse into the plurality of sub-pulses includes interleaving cycles represented by different bit values.

Example 8. The method of Example 7, further comprising interleaving the cycles using a counter circuit.

Example 9. The method of any of Examples 1-8, further comprising: receiving, from a neighboring pixel, a second pulse width value before the frame ends; sending, to a second neighboring pixel, the pulse width value; dividing the second pulse width value into a second plurality of sub-pulses; and activating the pixel for a remainder of the frame based on the second plurality of sub-pulses.

Example 10. A device comprising: a pixel circuit corresponding to a color channel; a plurality of bit circuits coupled to the pixel circuit; and a control circuit coupled to the plurality of bit circuits and configured to: receive a pulse width value corresponding to a pulse for activating the pixel circuit for a frame; divide the pulse into a plurality of sub-pulses; and activate the pixel circuit for the frame based on the plurality of sub-pulses.

Example 11. The device of Example 10, wherein the control circuit is configured to interleave active periods corresponding to the plurality of sub-pulses with inactive periods.

Example 12. The device of Example 10, further comprising a second pixel circuit corresponding to a second color channel; wherein the control circuit is configured to: receive a second pulse width value corresponding to a second pulse for activating the second pixel circuit for the frame; divide the second pulse into a second plurality of sub-pulses; and activate the second pixel circuit for the frame based on the second plurality of sub-pulses.

Example 13. The device of Example 12, wherein a ratio between the pulse and the second pulse is maintained for the plurality of sub-pulses and the second plurality of sub-pulses.

Example 14. The device of Example 13, wherein dividing the pulse into the plurality of sub-pulses is based on the ratio satisfying a ratio threshold.

Example 15. The device of any of Examples 10-14, wherein the pulse width value corresponds to a bit sequence representing decreasing numbers of cycles from a most significant bit (MSB) of the bit sequence to a least significant bit (LSB) of the bit sequence.

Example 16. The device of Example 15, wherein dividing the pulse into the plurality of sub-pulses includes interleaving cycles represented by different bit values.

Example 17. The device of Example 16, further comprising interleaving the cycles using a counter circuit.

Example 18. The device of any of Examples 10-17, wherein the control circuit is configured to: receive, from a neighboring pixel, a second pulse width value before the frame ends; send, to a second neighboring pixel, the pulse width value; divide the second pulse width value into a second plurality of sub-pulses; and activate the pixel for a remainder of the frame based on the second plurality of sub-pulses.

Example 19. A device comprising: a plurality of pixels; and a control circuit coupled to the plurality of pixels and configured to, for each pixel: receive a pulse width value corresponding to a pulse for activating the pixel for a frame; divide the pulse into a plurality of sub-pulses; and activate the pixel for the frame based on the plurality of sub-pulses.

Example 20. The device of Example 19 wherein the control circuit is configured to: send the pulse width value to a neighboring pixel before the frame ends; divide the pulse width value into a second plurality of sub-pulses; and activate the neighboring pixel for a remainder of the frame based on the second plurality of sub-pulses.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

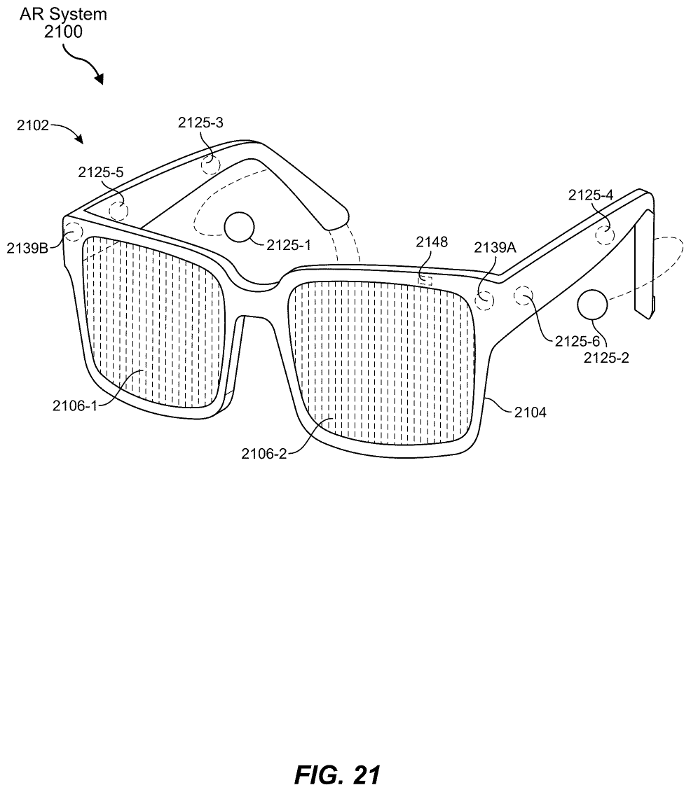

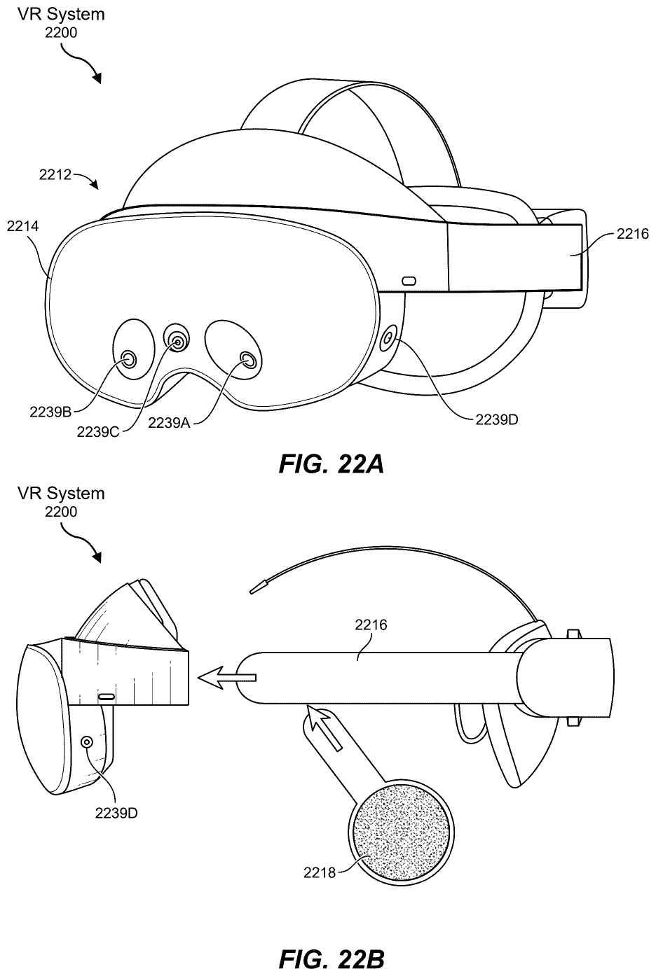

AR systems may be implemented in a variety of different form factors and configurations. Some AR systems may be designed to work without near-eye displays (NEDs). Other AR systems may include a NED that also provides visibility into the real world (such as, e.g., augmented-reality system 2100 in FIG. 21) or that visually immerses a user in an artificial reality (such as, e.g., virtual-reality system 2200 in FIGS. 22A and 22B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

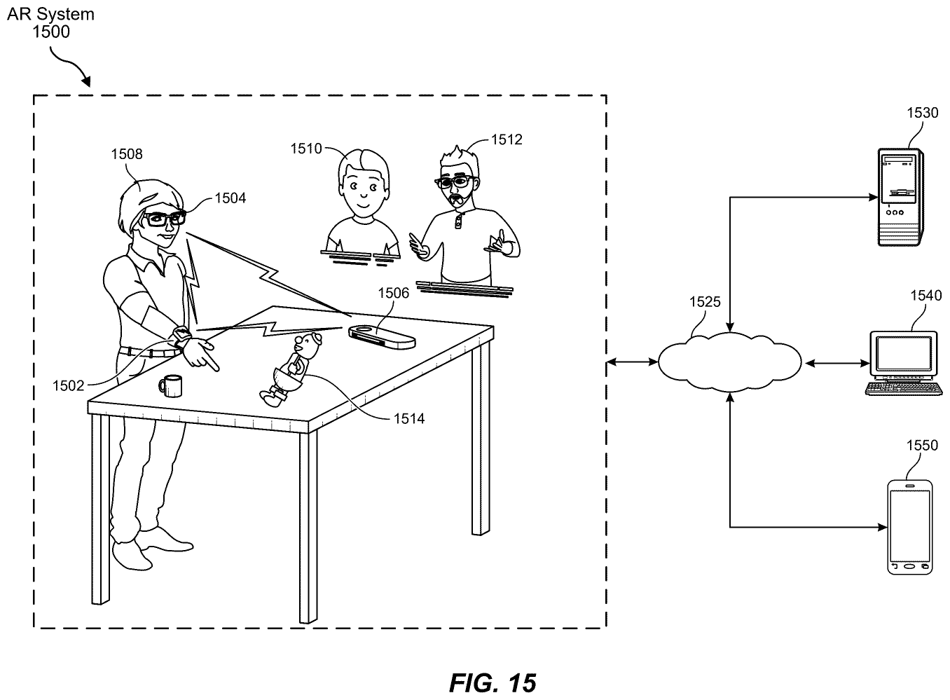

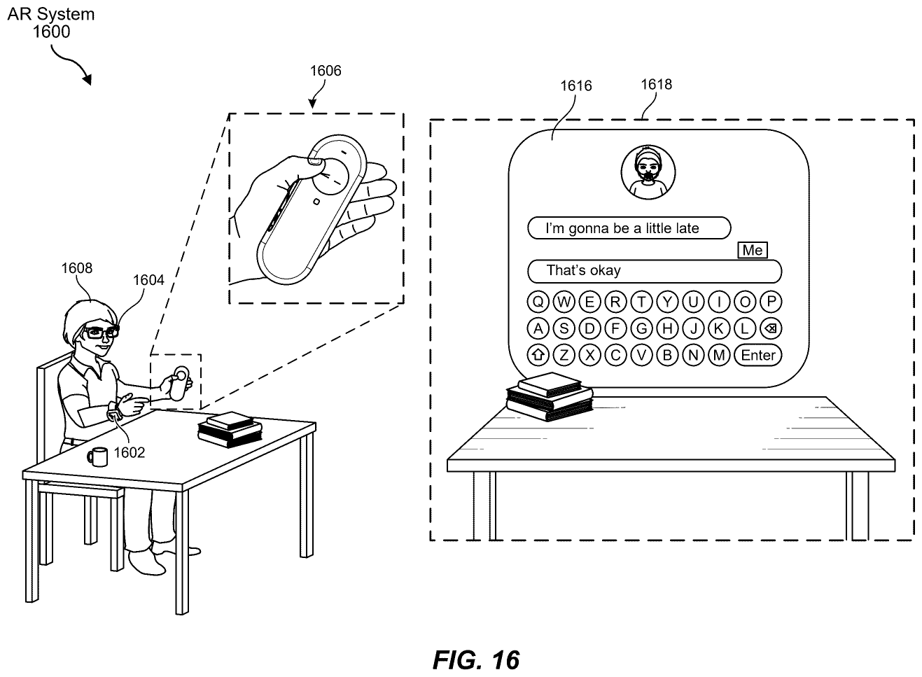

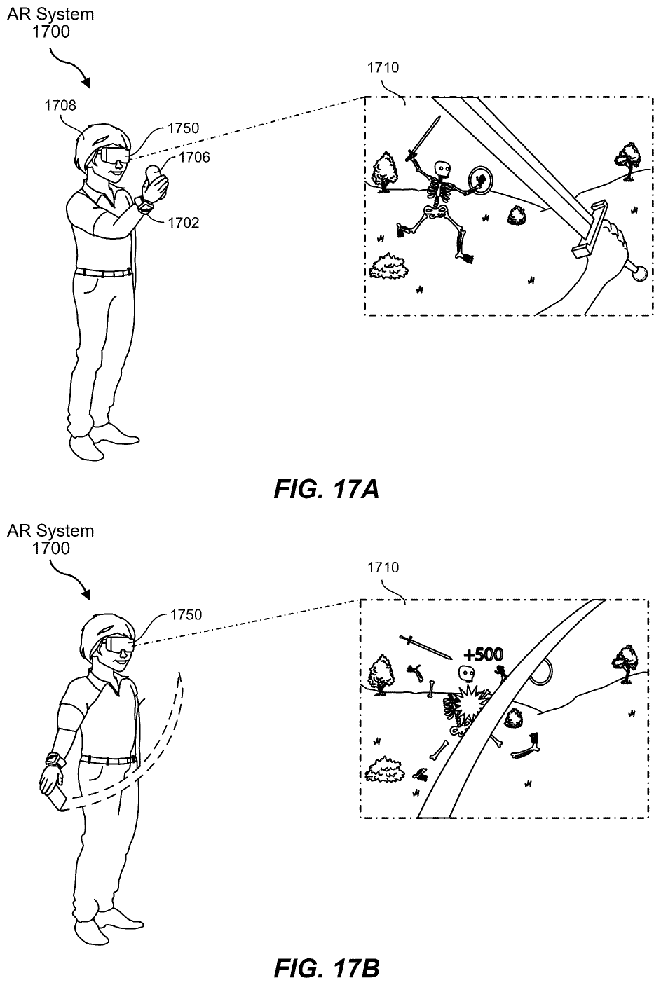

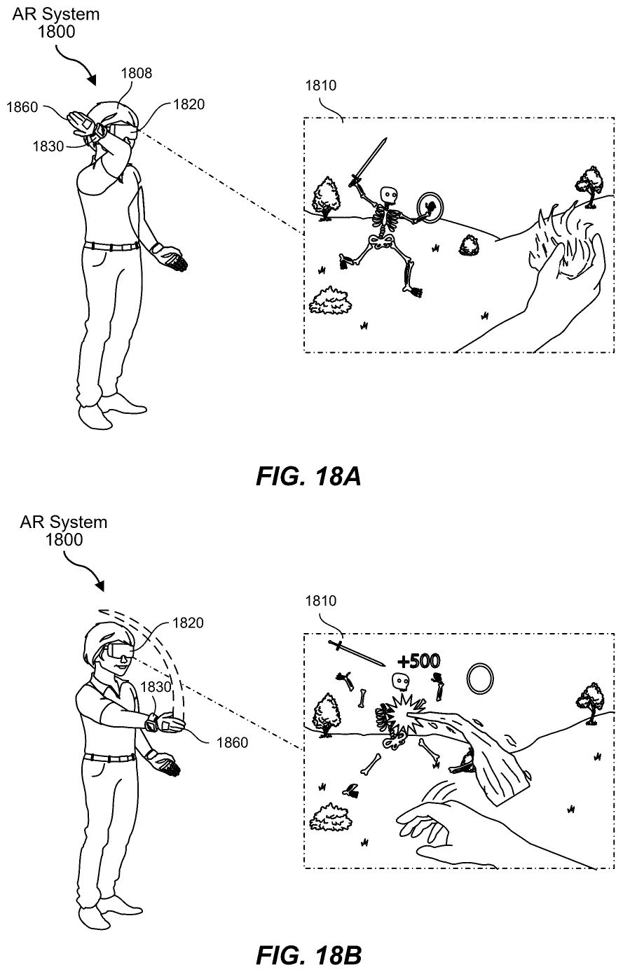

FIGS. 15-18B illustrate example artificial-reality (AR) systems in accordance with some embodiments. FIG. 15 shows a first AR system 1500 and first example user interactions using a wrist-wearable device 1502, a head-wearable device (e.g., AR glasses 2100), and/or a handheld intermediary processing device (HIPD) 1506. FIG. 16 shows a second AR system 1600 and second example user interactions using a wrist-wearable device 1602, AR glasses 1604, and/or an HIPD 1606. FIGS. 17A and 17B show a third AR system 1700 and third example user 1708 interactions using a wrist-wearable device 1702, a head-wearable device (e.g., VR headset 1750), and/or an HIPD 1706. FIGS. 18A and 18B show a fourth AR system 1800 and fourth example user 1808 interactions using a wrist-wearable device 1830, VR headset 1820, and/or a haptic device 1860 (e.g., wearable gloves).

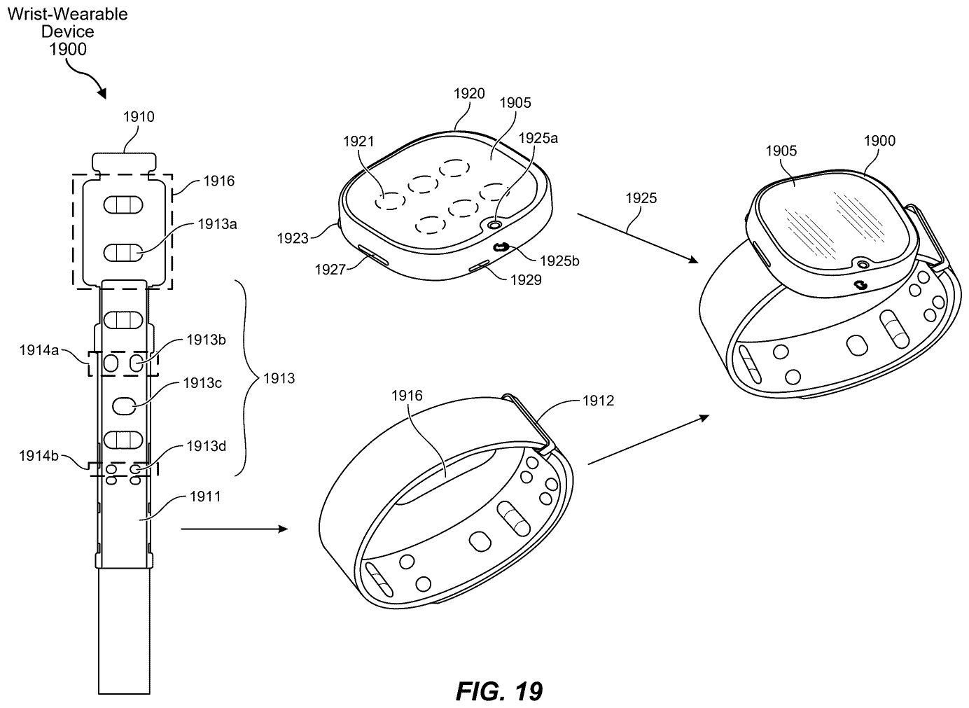

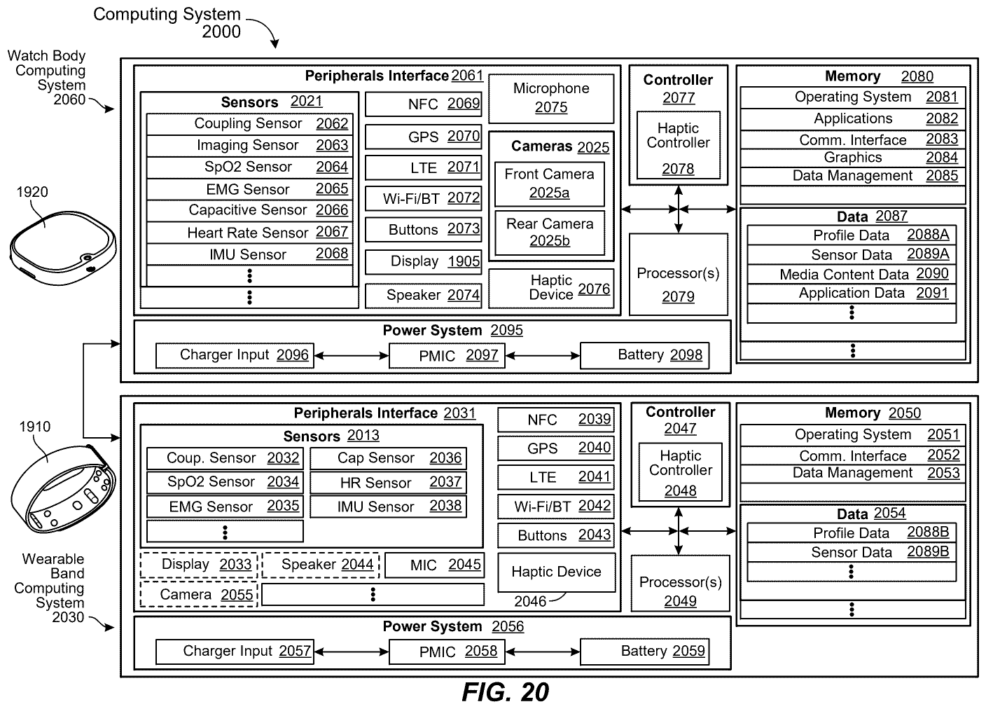

A wrist-wearable device 1900, which can be used for wrist-wearable device 1502, 1602, 1702, 1830, and one or more of its components, are described below in reference to FIGS. 19 and 20; head-wearable devices 2100 and 2200, which can respectively be used for AR glasses 1504, 1604 or VR headset 1750, 1820, and their one or more components are described below in reference to FIGS. 21-23.

Referring to FIG. 15, wrist-wearable device 1502, AR glasses 1504, and/or HIPD 1506 can communicatively couple via a network 1525 (e.g., cellular, near field, Wi-Fi, personal area network, wireless LAN, etc.). Additionally, wrist-wearable device 1502, AR glasses 1504, and/or HIPD 1506 can also communicatively couple with one or more servers 1530, computers 1540 (e.g., laptops, computers, etc.), mobile devices 1550 (e.g., smartphones, tablets, etc.), and/or other electronic devices via network 1525 (e.g., cellular, near field, Wi-Fi, personal area network, wireless LAN, etc.).

In FIG. 15, a user 1508 is shown wearing wrist-wearable device 1502 and AR glasses 1504 and having HIPD 1506 on their desk. The wrist-wearable device 1502, AR glasses 1504, and HIPD 1506 facilitate user interaction with an AR environment. In particular, as shown by first AR system 1500, wrist-wearable device 1502, AR glasses 1504, and/or HIPD 1506 cause presentation of one or more avatars 1510, digital representations of contacts 1512, and virtual objects 1514. As discussed below, user 1508 can interact with one or more avatars 1510, digital representations of contacts 1512, and virtual objects 1514 via wrist-wearable device 1502, AR glasses 1504, and/or HIPD 1506.

User 1508 can use any of wrist-wearable device 1502, AR glasses 1504, and/or HIPD 1506 to provide user inputs. For example, user 1508 can perform one or more hand gestures that are detected by wrist-wearable device 1502 (e.g., using one or more EMG sensors and/or IMUs, described below in reference to FIGS. 19 and 20) and/or AR glasses 1504 (e.g., using one or more image sensor or camera, described below in reference to FIGS. 21-10) to provide a user input. Alternatively, or additionally, user 1508 can provide a user input via one or more touch surfaces of wrist-wearable device 1502, AR glasses 1504, HIPD 1506, and/or voice commands captured by a microphone of wrist-wearable device 1502, AR glasses 1504, and/or HIPD 1506. In some embodiments, wrist-wearable device 1502, AR glasses 1504, and/or HIPD 1506 include a digital assistant to help user 1508 in providing a user input (e.g., completing a sequence of operations, suggesting different operations or commands, providing reminders, confirming a command, etc.). In some embodiments, user 1508 can provide a user input via one or more facial gestures and/or facial expressions. For example, cameras of wrist-wearable device 1502, AR glasses 1504, and/or HIPD 1506 can track eyes of user 1508 for navigating a user interface.

Wrist-wearable device 1502, AR glasses 1504, and/or HIPD 1506 can operate alone or in conjunction to allow user 1508 to interact with the AR environment. In some embodiments, HIPD 1506 is configured to operate as a central hub or control center for the wrist-wearable device 1502, AR glasses 1504, and/or another communicatively coupled device. For example, user 1508 can provide an input to interact with the AR environment at any of wrist-wearable device 1502, AR glasses 1504, and/or HIPD 1506, and HIPD 1506 can identify one or more back-end and front-end tasks to cause the performance of the requested interaction and distribute instructions to cause the performance of the one or more back-end and front-end tasks at wrist-wearable device 1502, AR glasses 1504, and/or HIPD 1506. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). As described below, HIPD 1506 can perform the back-end tasks and provide wrist-wearable device 1502 and/or AR glasses 1504 operational data corresponding to the performed back-end tasks such that wrist-wearable device 1502 and/or AR glasses 1504 can perform the front-end tasks. In this way, HIPD 1506, which has more computational resources and greater thermal headroom than wrist-wearable device 1502 and/or AR glasses 1504, performs computationally intensive tasks and reduces the computer resource utilization and/or power usage of wrist-wearable device 1502 and/or AR glasses 1504.

In the example shown by first AR system 1500, HIPD 1506 identifies one or more back-end tasks and front-end tasks associated with a user request to initiate an AR video call with one or more other users (represented by avatar 1510 and the digital representation of contact 1512) and distributes instructions to cause the performance of the one or more back-end tasks and front-end tasks. In particular, HIPD 1506 performs back-end tasks for processing and/or rendering image data (and other data) associated with the AR video call and provides operational data associated with the performed back-end tasks to AR glasses 1504 such that the AR glasses 1504 perform front-end tasks for presenting the AR video call (e.g., presenting avatar 1510 and digital representation of contact 1512).

In some embodiments, HIPD 1506 can operate as a focal or anchor point for causing the presentation of information. This allows user 1508 to be generally aware of where information is presented. For example, as shown in first AR system 1500, avatar 1510 and the digital representation of contact 1512 are presented above HIPD 1506. In particular, HIPD 1506 and AR glasses 1504 operate in conjunction to determine a location for presenting avatar 1510 and the digital representation of contact 1512. In some embodiments, information can be presented a predetermined distance from HIPD 1506 (e.g., within 5 meters). For example, as shown in first AR system 1500, virtual object 1514 is presented on the desk some distance from HIPD 1506. Similar to the above example, HIPD 1506 and AR glasses 1504 can operate in conjunction to determine a location for presenting virtual object 1514. Alternatively, in some embodiments, presentation of information is not bound by HIPD 1506. More specifically, avatar 1510, digital representation of contact 1512, and virtual object 1514 do not have to be presented within a predetermined distance of HIPD 1506.

User inputs provided at wrist-wearable device 1502, AR glasses 1504, and/or HIPD 1506 are coordinated such that the user can use any device to initiate, continue, and/or complete an operation. For example, user 1508 can provide a user input to AR glasses 1504 to cause AR glasses 1504 to present virtual object 1514 and, while virtual object 1514 is presented by AR glasses 1504, user 1508 can provide one or more hand gestures via wrist-wearable device 1502 to interact and/or manipulate virtual object 1514.

FIG. 16 shows a user 1608 wearing a wrist-wearable device 1602 and AR glasses 1604, and holding an HIPD 1606. In second AR system 1600, the wrist-wearable device 1602, AR glasses 1604, and/or HIPD 1606 are used to receive and/or provide one or more messages to a contact of user 1608. In particular, wrist-wearable device 1602, AR glasses 1604, and/or HIPD 1606 detect and coordinate one or more user inputs to initiate a messaging application and prepare a response to a received message via the messaging application.

In some embodiments, user 1608 initiates, via a user input, an application on wrist-wearable device 1602, AR glasses 1604, and/or HIPD 1606 that causes the application to initiate on at least one device. For example, in second AR system 1600, user 1608 performs a hand gesture associated with a command for initiating a messaging application (represented by messaging user interface 1616), wrist-wearable device 1602 detects the hand gesture and, based on a determination that user 1608 is wearing AR glasses 1604, causes AR glasses 1604 to present a messaging user interface 1616 of the messaging application. AR glasses 1604 can present messaging user interface 1616 to user 1608 via its display (e.g., as shown by a field of view 1618 of user 1608). In some embodiments, the application is initiated and executed on the device (e.g., wrist-wearable device 1602, AR glasses 1604, and/or HIPD 1606) that detects the user input to initiate the application, and the device provides another device operational data to cause the presentation of the messaging application. For example, wrist-wearable device 1602 can detect the user input to initiate a messaging application, initiate and run the messaging application, and provide operational data to AR glasses 1604 and/or HIPD 1606 to cause presentation of the messaging application. Alternatively, the application can be initiated and executed at a device other than the device that detected the user input. For example, wrist-wearable device 1602 can detect the hand gesture associated with initiating the messaging application and cause HIPD 1606 to run the messaging application and coordinate the presentation of the messaging application.

Further, user 1608 can provide a user input provided at wrist-wearable device 1602, AR glasses 1604, and/or HIPD 1606 to continue and/or complete an operation initiated at another device. For example, after initiating the messaging application via wrist-wearable device 1602 and while AR glasses 1604 present messaging user interface 1616, user 1608 can provide an input at HIPD 1606 to prepare a response (e.g., shown by the swipe gesture performed on HIPD 1606). Gestures performed by user 1608 on HIPD 1606 can be provided and/or displayed on another device. For example, a swipe gestured performed on HIPD 1606 is displayed on a virtual keyboard of messaging user interface 1616 displayed by AR glasses 1604.

In some embodiments, wrist-wearable device 1602, AR glasses 1604, HIPD 1606, and/or any other communicatively coupled device can present one or more notifications to user 1608. The notification can be an indication of a new message, an incoming call, an application update, a status update, etc. User 1608 can select the notification via wrist-wearable device 1602, AR glasses 1604, and/or HIPD 1606 and can cause presentation of an application or operation associated with the notification on at least one device. For example, user 1608 can receive a notification that a message was received at wrist-wearable device 1602, AR glasses 1604, HIPD 1606, and/or any other communicatively coupled device and can then provide a user input at wrist-wearable device 1602, AR glasses 1604, and/or HIPD 1606 to review the notification, and the device detecting the user input can cause an application associated with the notification to be initiated and/or presented at wrist-wearable device 1602, AR glasses 1604, and/or HIPD 1606.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 1604 can present to user 1608 game application data, and HIPD 1606 can be used as a controller to provide inputs to the game. Similarly, user 1608 can use wrist-wearable device 1602 to initiate a camera of AR glasses 1604, and user 1608 can use wrist-wearable device 1602, AR glasses 1604, and/or HIPD 1606 to manipulate the image capture (e.g., zoom in or out, apply filters, etc.) and capture image data.

Users may interact with the devices disclosed herein in a variety of ways. For example, as shown in FIGS. 17A and 17B, a user 1708 may interact with an AR system 1700 by donning a VR headset 1750 while holding HIPD 1706 and wearing wrist-wearable device 1702. In this example, AR system 1700 may enable a user to interact with a game 1710 by swiping their arm. One or more of VR headset 1750, HIPD 1706, and wrist-wearable device 1702 may detect this gesture and, in response, may display a sword strike in game 1710. Similarly, in FIGS. 18A and 18B, a user 1808 may interact with an AR system 1800 by donning a VR headset 1820 while wearing haptic device 1860 and wrist-wearable device 1830. In this example, AR system 1800 may enable a user to interact with a game 1810 by swiping their arm. One or more of VR headset 1820, haptic device 1860, and wrist-wearable device 1830 may detect this gesture and, in response, may display a spell being cast in game 1710.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiogra sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 19 and 20 illustrate an example wrist-wearable device 1900 and an example computer system 2000, in accordance with some embodiments. Wrist-wearable device 1900 is an instance of wearable device 1502 described in FIG. 15 herein, such that the wearable device 1502 should be understood to have the features of the wrist-wearable device 1900 and vice versa. FIG. 20 illustrates components of the wrist-wearable device 1900, which can be used individually or in combination, including combinations that include other electronic devices and/or electronic components.

FIG. 19 shows a wearable band 1910 and a watch body 1920 (or capsule) being coupled, as discussed below, to form wrist-wearable device 1900. Wrist-wearable device 1900 can perform various functions and/or operations associated with navigating through user interfaces and selectively opening applications as well as the functions and/or operations described above with reference to FIGS. 15-18B.

As will be described in more detail below, operations executed by wrist-wearable device 1900 can include (i) presenting content to a user (e.g., displaying visual content via a display 1905), (ii) detecting (e.g., sensing) user input (e.g., sensing a touch on peripheral button 1923 and/or at a touch screen of the display 1905, a hand gesture detected by sensors (e.g., biopotential sensors)), (iii) sensing biometric data (e.g., neuromuscular signals, heart rate, temperature, sleep, etc.) via one or more sensors 1913, messaging (e.g., text, speech, video, etc.); image capture via one or more imaging devices or cameras 1925, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 1920, independently in wearable band 1910, and/or via an electronic communication between watch body 1920 and wearable band 1910. In some embodiments, functions can be executed on wrist-wearable device 1900 while an AR environment is being presented (e.g., via one of AR systems 1500 to 1800). The wearable devices described herein can also be used with other types of AR environments.

Wearable band 1910 can be configured to be worn by a user such that an inner surface of a wearable structure 1911 of wearable band 1910 is in contact with the user's skin. In this example, when worn by a user, sensors 1913 may contact the user's skin. In some examples, one or more of sensors 1913 can sense biometric data such as a user's heart rate, a saturated oxygen level, temperature, sweat level, neuromuscular signals, or a combination thereof. One or more of sensors 1913 can also sense data about a user's environment including a user's motion, altitude, location, orientation, gait, acceleration, position, or a combination thereof. In some embodiment, one or more of sensors 1913 can be configured to track a position and/or motion of wearable band 1910. One or more of sensors 1913 can include any of the sensors defined above and/or discussed below with respect to FIG. 19.

One or more of sensors 1913 can be distributed on an inside and/or an outside surface of wearable band 1910. In some embodiments, one or more of sensors 1913 are uniformly spaced along wearable band 1910. Alternatively, in some embodiments, one or more of sensors 1913 are positioned at distinct points along wearable band 1910. As shown in FIG. 19, one or more of sensors 1913 can be the same or distinct. For example, in some embodiments, one or more of sensors 1913 can be shaped as a pill (e.g., sensor 1913a), an oval, a circle a square, an oblong (e.g., sensor 1913c) and/or any other shape that maintains contact with the user's skin (e.g., such that neuromuscular signal and/or other biometric data can be accurately measured at the user's skin). In some embodiments, one or more sensors of 1913 are aligned to form pairs of sensors (e.g., for sensing neuromuscular signals based on differential sensing within each respective sensor). For example, sensor 1913b may be aligned with an adjacent sensor to form sensor pair 1914a and sensor 1913d may be aligned with an adjacent sensor to form sensor pair 1914b. In some embodiments, wearable band 1910 does not have a sensor pair. Alternatively, in some embodiments, wearable band 1910 has a predetermined number of sensor pairs (one pair of sensors, three pairs of sensors, four pairs of sensors, six pairs of sensors, sixteen pairs of sensors, etc.).

Wearable band 1910 can include any suitable number of sensors 1913. In some embodiments, the number and arrangement of sensors 1913 depends on the particular application for which wearable band 1910 is used. For instance, wearable band 1910 can be configured as an armband, wristband, or chest-band that include a plurality of sensors 1913 with different number of sensors 1913, a variety of types of individual sensors with the plurality of sensors 1913, and different arrangements for each use case, such as medical use cases as compared to gaming or general day-to-day use cases.

In accordance with some embodiments, wearable band 1910 further includes an electrical ground electrode and a shielding electrode. The electrical ground and shielding electrodes, like the sensors 1913, can be distributed on the inside surface of the wearable band 1910 such that they contact a portion of the user's skin. For example, the electrical ground and shielding electrodes can be at an inside surface of a coupling mechanism 1916 or an inside surface of a wearable structure 1911. The electrical ground and shielding electrodes can be formed and/or use the same components as sensors 1913. In some embodiments, wearable band 1910 includes more than one electrical ground electrode and more than one shielding electrode.

Sensors 1913 can be formed as part of wearable structure 1911 of wearable band 1910. In some embodiments, sensors 1913 are flush or substantially flush with wearable structure 1911 such that they do not extend beyond the surface of wearable structure 1911. While flush with wearable structure 1911, sensors 1913 are still configured to contact the user's skin (e.g., via a skin-contacting surface). Alternatively, in some embodiments, sensors 1913 extend beyond wearable structure 1911 a predetermined distance (e.g., 0.1-2 mm) to make contact and depress into the user's skin. In some embodiment, sensors 1913 are coupled to an actuator (not shown) configured to adjust an extension height (e.g., a distance from the surface of wearable structure 1911) of sensors 1913 such that sensors 1913 make contact and depress into the user's skin. In some embodiments, the actuators adjust the extension height between 0.01 mm-1.2 mm. This may allow a the user to customize the positioning of sensors 1913 to improve the overall comfort of the wearable band 1910 when worn while still allowing sensors 1913 to contact the user's skin. In some embodiments, sensors 1913 are indistinguishable from wearable structure 1911 when worn by the user.

Wearable structure 1911 can be formed of an elastic material, elastomers, etc., configured to be stretched and fitted to be worn by the user. In some embodiments, wearable structure 1911 is a textile or woven fabric. As described above, sensors 1913 can be formed as part of a wearable structure 1911. For example, sensors 1913 can be molded into the wearable structure 1911, be integrated into a woven fabric (e.g., sensors 1913 can be sewn into the fabric and mimic the pliability of fabric and can and/or be constructed from a series woven strands of fabric).

Wearable structure 1911 can include flexible electronic connectors that interconnect sensors 1913, the electronic circuitry, and/or other electronic components (described below in reference to FIG. 20) that are enclosed in wearable band 1910. In some embodiments, the flexible electronic connectors are configured to interconnect sensors 1913, the electronic circuitry, and/or other electronic components of wearable band 1910 with respective sensors and/or other electronic components of another electronic device (e.g., watch body 1920). The flexible electronic connectors are configured to move with wearable structure 1911 such that the user adjustment to wearable structure 1911 (e.g., resizing, pulling, folding, etc.) does not stress or strain the electrical coupling of components of wearable band 1910.

As described above, wearable band 1910 is configured to be worn by a user. In particular, wearable band 1910 can be shaped or otherwise manipulated to be worn by a user. For example, wearable band 1910 can be shaped to have a substantially circular shape such that it can be configured to be worn on the user's lower arm or wrist. Alternatively, wearable band 1910 can be shaped to be worn on another body part of the user, such as the user's upper arm (e.g., around a bicep), forearm, chest, legs, etc. Wearable band 1910 can include a retaining mechanism 1912 (e.g., a buckle, a hook and loop fastener, etc.) for securing wearable band 1910 to the user's wrist or other body part. While wearable band 1910 is worn by the user, sensors 1913 sense data (referred to as sensor data) from the user's skin. In some examples, sensors 1913 of wearable band 1910 obtain (e.g., sense and record) neuromuscular signals.

The sensed data (e.g., sensed neuromuscular signals) can be used to detect and/or determine the user's intention to perform certain motor actions. In some examples, sensors 1913 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 1905 of wrist-wearable device 1900 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 1913 can be used to provide a user with an enhanced interaction with a physical object (e.g., devices communicatively coupled with wearable band 1910) and/or a virtual object in an artificial-reality application generated by an artificial-reality system (e.g., user interface objects presented on the display 1905, or another computing device (e.g., a smartphone)).

In some embodiments, wearable band 1910 includes one or more haptic devices 2046 (e.g., a vibratory haptic actuator) that are configured to provide haptic feedback (e.g., a cutaneous and/or kinesthetic sensation, etc.) to the user's skin. Sensors 1913 and/or haptic devices 2046 (shown in FIG. 20) can be configured to operate in conjunction with multiple applications including, without limitation, health monitoring, social media, games, and artificial reality (e.g., the applications associated with artificial reality).

Wearable band 1910 can also include coupling mechanism 1916 for detachably coupling a capsule (e.g., a computing unit) or watch body 1920 (via a coupling surface of the watch body 1920) to wearable band 1910. For example, a cradle or a shape of coupling mechanism 1916 can correspond to shape of watch body 1920 of wrist-wearable device 1900. In particular, coupling mechanism 1916 can be configured to receive a coupling surface proximate to the bottom side of watch body 1920 (e.g., a side opposite to a front side of watch body 1920 where display 1905 is located), such that a user can push watch body 1920 downward into coupling mechanism 1916 to attach watch body 1920 to coupling mechanism 1916. In some embodiments, coupling mechanism 1916 can be configured to receive a top side of the watch body 1920 (e.g., a side proximate to the front side of watch body 1920 where display 1905 is located) that is pushed upward into the cradle, as opposed to being pushed downward into coupling mechanism 1916. In some embodiments, coupling mechanism 1916 is an integrated component of wearable band 1910 such that wearable band 1910 and coupling mechanism 1916 are a single unitary structure. In some embodiments, coupling mechanism 1916 is a type of frame or shell that allows watch body 1920 coupling surface to be retained within or on wearable band 1910 coupling mechanism 1916 (e.g., a cradle, a tracker band, a support base, a clasp, etc.).

Coupling mechanism 1916 can allow for watch body 1920 to be detachably coupled to the wearable band 1910 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 1920 to wearable band 1910 and to decouple the watch body 1920 from the wearable band 1910. For example, a user can twist, slide, turn, push, pull, or rotate watch body 1920 relative to wearable band 1910, or a combination thereof, to attach watch body 1920 to wearable band 1910 and to detach watch body 1920 from wearable band 1910. Alternatively, as discussed below, in some embodiments, the watch body 1920 can be decoupled from the wearable band 1910 by actuation of a release mechanism 1929.

Wearable band 1910 can be coupled with watch body 1920 to increase the functionality of wearable band 1910 (e.g., converting wearable band 1910 into wrist-wearable device 1900, adding an additional computing unit and/or battery to increase computational resources and/or a battery life of wearable band 1910, adding additional sensors to improve sensed data, etc.). As described above, wearable band 1910 and coupling mechanism 1916 are configured to operate independently (e.g., execute functions independently) from watch body 1920. For example, coupling mechanism 1916 can include one or more sensors 1913 that contact a user's skin when wearable band 1910 is worn by the user, with or without watch body 1920 and can provide sensor data for determining control commands.

A user can detach watch body 1920 from wearable band 1910 to reduce the encumbrance of wrist-wearable device 1900 to the user. For embodiments in which watch body 1920 is removable, watch body 1920 can be referred to as a removable structure, such that in these embodiments wrist-wearable device 1900 includes a wearable portion (e.g., wearable band 1910) and a removable structure (e.g., watch body 1920).

Turning to watch body 1920, in some examples watch body 1920 can have a substantially rectangular or circular shape. Watch body 1920 is configured to be worn by the user on their wrist or on another body part. More specifically, watch body 1920 is sized to be easily carried by the user, attached on a portion of the user's clothing, and/or coupled to wearable band 1910 (forming the wrist-wearable device 1900). As described above, watch body 1920 can have a shape corresponding to coupling mechanism 1916 of wearable band 1910. In some embodiments, watch body 1920 includes a single release mechanism 1929 or multiple release mechanisms (e.g., two release mechanisms 1929 positioned on opposing sides of watch body 1920, such as spring-loaded buttons) for decoupling watch body 1920 from wearable band 1910. Release mechanism 1929 can include, without limitation, a button, a knob, a plunger, a handle, a lever, a fastener, a clasp, a dial, a latch, or a combination thereof.

A user can actuate release mechanism 1929 by pushing, turning, lifting, depressing, shifting, or performing other actions on release mechanism 1929. Actuation of release mechanism 1929 can release (e.g., decouple) watch body 1920 from coupling mechanism 1916 of wearable band 1910, allowing the user to use watch body 1920 independently from wearable band 1910 and vice versa. For example, decoupling watch body 1920 from wearable band 1910 can allow a user to capture images using rear-facing camera 1925b. Although release mechanism 1929 is shown positioned at a corner of watch body 1920, release mechanism 1929 can be positioned anywhere on watch body 1920 that is convenient for the user to actuate. In addition, in some embodiments, wearable band 1910 can also include a respective release mechanism for decoupling watch body 1920 from coupling mechanism 1916. In some embodiments, release mechanism 1929 is optional and watch body 1920 can be decoupled from coupling mechanism 1916 as described above (e.g., via twisting, rotating, etc.).

Watch body 1920 can include one or more peripheral buttons 1923 and 1927 for performing various operations at watch body 1920. For example, peripheral buttons 1923 and 1927 can be used to turn on or wake (e.g., transition from a sleep state to an active state) display 1905, unlock watch body 1920, increase or decrease a volume, increase or decrease a brightness, interact with one or more applications, interact with one or more user interfaces, etc. Additionally or alternatively, in some embodiments, display 1905 operates as a touch screen and allows the user to provide one or more inputs for interacting with watch body 1920.

In some embodiments, watch body 1920 includes one or more sensors 1921. Sensors 1921 of watch body 1920 can be the same or distinct from sensors 1913 of wearable band 1910. Sensors 1921 of watch body 1920 can be distributed on an inside and/or an outside surface of watch body 1920. In some embodiments, sensors 1921 are configured to contact a user's skin when watch body 1920 is worn by the user. For example, sensors 1921 can be placed on the bottom side of watch body 1920 and coupling mechanism 1916 can be a cradle with an opening that allows the bottom side of watch body 1920 to directly contact the user's skin. Alternatively, in some embodiments, watch body 1920 does not include sensors that are configured to contact the user's skin (e.g., including sensors internal and/or external to the watch body 1920 that are configured to sense data of watch body 1920 and the surrounding environment). In some embodiments, sensors 1921 are configured to track a position and/or motion of watch body 1920.

Watch body 1920 and wearable band 1910 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 1920 and wearable band 1910 can share data sensed by sensors 1913 and 1921, as well as application and device specific information (e.g., active and/or available applications, output devices (e.g., displays, speakers, etc.), input devices (e.g., touch screens, microphones, imaging sensors, etc.).

In some embodiments, watch body 1920 can include, without limitation, a front-facing camera 1925a and/or a rear-facing camera 1925b, sensors 1921 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 2063), a touch sensor, a sweat sensor, etc.). In some embodiments, watch body 1920 can include one or more haptic devices 2076 (e.g., a vibratory haptic actuator) that is configured to provide haptic feedback (e.g., a cutaneous and/or kinesthetic sensation, etc.) to the user. Sensors 2021 and/or haptic device 2076 can also be configured to operate in conjunction with multiple applications including, without limitation, health monitoring applications, social media applications, game applications, and artificial reality applications (e.g., the applications associated with artificial reality).

As described above, watch body 1920 and wearable band 1910, when coupled, can form wrist-wearable device 1900. When coupled, watch body 1920 and wearable band 1910 may operate as a single device to execute functions (operations, detections, communications, etc.) described herein. In some embodiments, each device may be provided with particular instructions for performing the one or more operations of wrist-wearable device 1900. For example, in accordance with a determination that watch body 1920 does not include neuromuscular signal sensors, wearable band 1910 can include alternative instructions for performing associated instructions (e.g., providing sensed neuromuscular signal data to watch body 1920 via a different electronic device). Operations of wrist-wearable device 1900 can be performed by watch body 1920 alone or in conjunction with wearable band 1910 (e.g., via respective processors and/or hardware components) and vice versa. In some embodiments, operations of wrist-wearable device 1900, watch body 1920, and/or wearable band 1910 can be performed in conjunction with one or more processors and/or hardware components.

As described below with reference to the block diagram of FIG. 20, wearable band 1910 and/or watch body 1920 can each include independent resources required to independently execute functions. For example, wearable band 1910 and/or watch body 1920 can each include a power source (e.g., a battery), a memory, data storage, a processor (e.g., a central processing unit (CPU)), communications, a light source, and/or input/output devices.

FIG. 20 shows block diagrams of a computing system 2030 corresponding to wearable band 1910 and a computing system 2060 corresponding to watch body 1920 according to some embodiments. Computing system 2000 of wrist-wearable device 1900 may include a combination of components of wearable band computing system 2030 and watch body computing system 2060, in accordance with some embodiments.

Watch body 1920 and/or wearable band 1910 can include one or more components shown in watch body computing system 2060. In some embodiments, a single integrated circuit may include all or a substantial portion of the components of watch body computing system 2060 included in a single integrated circuit. Alternatively, in some embodiments, components of the watch body computing system 2060 may be included in a plurality of integrated circuits that are communicatively coupled. In some embodiments, watch body computing system 2060 may be configured to couple (e.g., via a wired or wireless connection) with wearable band computing system 2030, which may allow the computing systems to share components, distribute tasks, and/or perform other operations described herein (individually or as a single device).

Watch body computing system 2060 can include one or more processors 2079, a controller 2077, a peripherals interface 2061, a power system 2095, and memory (e.g., a memory 2080).

Power system 2095 can include a charger input 2096, a power-management integrated circuit (PMIC) 2097, and a battery 2098. In some embodiments, a watch body 1920 and a wearable band 1910 can have respective batteries (e.g., battery 2098 and 2059) and can share power with each other. Watch body 1920 and wearable band 1910 can receive a charge using a variety of techniques. In some embodiments, watch body 1920 and wearable band 1910 can use a wired charging assembly (e.g., power cords) to receive the charge. Alternatively, or in addition, watch body 1920 and/or wearable band 1910 can be configured for wireless charging. For example, a portable charging device can be designed to mate with a portion of watch body 1920 and/or wearable band 1910 and wirelessly deliver usable power to battery 2098 of watch body 1920 and/or battery 2059 of wearable band 1910. Watch body 1920 and wearable band 1910 can have independent power systems (e.g., power system 2095 and 2056, respectively) to enable each to operate independently. Watch body 1920 and wearable band 1910 can also share power (e.g., one can charge the other) via respective PMICs (e.g., PMICs 2097 and 2058) and charger inputs (e.g., 2057 and 2096) that can share power over power and ground conductors and/or over wireless charging antennas.

In some embodiments, peripherals interface 2061 can include one or more sensors 2021. Sensors 2021 can include one or more coupling sensors 2062 for detecting when watch body 1920 is coupled with another electronic device (e.g., a wearable band 1910). Sensors 2021 can include one or more imaging sensors 2063 (e.g., one or more of cameras 2025, and/or separate imaging sensors 2063 (e.g., thermal-imaging sensors)). In some embodiments, sensors 2021 can include one or more SpO2 sensors 2064. In some embodiments, sensors 2021 can include one or more biopotential-signal sensors (e.g., EMG sensors 2065, which may be disposed on an interior, user-facing portion of watch body 1920 and/or wearable band 1910). In some embodiments, sensors 2021 may include one or more capacitive sensors 2066. In some embodiments, sensors 2021 may include one or more heart rate sensors 2067. In some embodiments, sensors 2021 may include one or more IMU sensors 2068. In some embodiments, one or more IMU sensors 2068 can be configured to detect movement of a user's hand or other location where watch body 1920 is placed or held.

In some embodiments, one or more of sensors 2021 may provide an example human-machine interface. For example, a set of neuromuscular sensors, such as EMG sensors 2065, may be arranged circumferentially around wearable band 1910 with an interior surface of EMG sensors 2065 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 1910 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 2079. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 2065 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 2061 includes a near-field communication (NFC) component 2069, a global-position system (GPS) component 2070, a long-term evolution (LTE) component 2071, and/or a Wi-Fi and/or Bluetooth communication component 2072. In some embodiments, peripherals interface 2061 includes one or more buttons 2073 (e.g., peripheral buttons 1923 and 1927 in FIG. 19), which, when selected by a user, cause operation to be performed at watch body 1920. In some embodiments, the peripherals interface 2061 includes one or more indicators, such as a light emitting diode (LED), to provide a user with visual indicators (e.g., message received, low battery, active microphone and/or camera, etc.).

Watch body 1920 can include at least one display 1905 for displaying visual representations of information or data to a user, including user-interface elements and/or three-dimensional virtual objects. The display can also include a touch screen for inputting user inputs, such as touch gestures, swipe gestures, and the like. Watch body 1920 can include at least one speaker 2074 and at least one microphone 2075 for providing audio signals to the user and receiving audio input from the user. The user can provide user inputs through microphone 2075 and can also receive audio output from speaker 2074 as part of a haptic event provided by haptic controller 2078. Watch body 1920 can include at least one camera 2025, including a front camera 2025a and a rear camera 2025b. Cameras 2025 can include ultra-wide-angle cameras, wide angle cameras, fish-eye cameras, spherical cameras, telephoto cameras, depth-sensing cameras, or other types of cameras.

Watch body computing system 2060 can include one or more haptic controllers 2078 and associated componentry (e.g., haptic devices 2076) for providing haptic events at watch body 1920 (e.g., a vibrating sensation or audio output in response to an event at the watch body 1920). Haptic controllers 2078 can communicate with one or more haptic devices 2076, such as electroacoustic devices, including a speaker of the one or more speakers 2074 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 2078 can provide haptic events to that are capable of being sensed by a user of watch body 1920. In some embodiments, one or more haptic controllers 2078 can receive input signals from an application of applications 2082.

In some embodiments, wearable band computing system 2030 and/or watch body computing system 2060 can include memory 2080, which can be controlled by one or more memory controllers of controllers 2077. In some embodiments, software components stored in memory 2080 include one or more applications 2082 configured to perform operations at the watch body 1920. In some embodiments, one or more applications 2082 may include games, word processors, messaging applications, calling applications, web browsers, social media applications, media streaming applications, financial applications, calendars, clocks, etc. In some embodiments, software components stored in memory 2080 include one or more communication interface modules 2083 as defined above. In some embodiments, software components stored in memory 2080 include one or more graphics modules 2084 for rendering, encoding, and/or decoding audio and/or visual data and one or more data management modules 2085 for collecting, organizing, and/or providing access to data 2087 stored in memory 2080. In some embodiments, one or more of applications 2082 and/or one or more modules can work in conjunction with one another to perform various tasks at the watch body 1920.

In some embodiments, software components stored in memory 2080 can include one or more operating systems 2081 (e.g., a Linux-based operating system, an Android operating system, etc.). Memory 2080 can also include data 2087. Data 2087 can include profile data 2088A, sensor data 2089A, media content data 2090, and application data 2091.

It should be appreciated that watch body computing system 2060 is an example of a computing system within watch body 1920, and that watch body 1920 can have more or fewer components than shown in watch body computing system 2060, can combine two or more components, and/or can have a different configuration and/or arrangement of the components. The various components shown in watch body computing system 2060 are implemented in hardware, software, firmware, or a combination thereof, including one or more signal processing and/or application-specific integrated circuits.

Turning to the wearable band computing system 2030, one or more components that can be included in wearable band 1910 are shown. Wearable band computing system 2030 can include more or fewer components than shown in watch body computing system 2060, can combine two or more components, and/or can have a different configuration and/or arrangement of some or all of the components. In some embodiments, all, or a substantial portion of the components of wearable band computing system 2030 are included in a single integrated circuit. Alternatively, in some embodiments, components of wearable band computing system 2030 are included in a plurality of integrated circuits that are communicatively coupled. As described above, in some embodiments, wearable band computing system 2030 is configured to couple (e.g., via a wired or wireless connection) with watch body computing system 2060, which allows the computing systems to share components, distribute tasks, and/or perform other operations described herein (individually or as a single device).

Wearable band computing system 2030, similar to watch body computing system 2060, can include one or more processors 2049, one or more controllers 2047 (including one or more haptics controllers 2048), a peripherals interface 2031 that can includes one or more sensors 2013 and other peripheral devices, a power source (e.g., a power system 2056), and memory (e.g., a memory 2050) that includes an operating system (e.g., an operating system 2051), data (e.g., data 2054 including profile data 2088B, sensor data 2089B, etc.), and one or more modules (e.g., a communications interface module 2052, a data management module 2053, etc.).

One or more of sensors 2013 can be analogous to sensors 2021 of watch body computing system 2060. For example, sensors 2013 can include one or more coupling sensors 2032, one or more SpO2 sensors 2034, one or more EMG sensors 2035, one or more capacitive sensors 2036, one or more heart rate sensors 2037, and one or more IMU sensors 2038.

Peripherals interface 2031 can also include other components analogous to those included in peripherals interface 2061 of watch body computing system 2060, including an NFC component 2039, a GPS component 2040, an LTE component 2041, a Wi-Fi and/or Bluetooth communication component 2042, and/or one or more haptic devices 2046 as described above in reference to peripherals interface 2061. In some embodiments, peripherals interface 2031 includes one or more buttons 2043, a display 2033, a speaker 2044, a microphone 2045, and a camera 2055. In some embodiments, peripherals interface 2031 includes one or more indicators, such as an LED.

It should be appreciated that wearable band computing system 2030 is an example of a computing system within wearable band 1910, and that wearable band 1910 can have more or fewer components than shown in wearable band computing system 2030, combine two or more components, and/or have a different configuration and/or arrangement of the components. The various components shown in wearable band computing system 2030 can be implemented in one or more of a combination of hardware, software, or firmware, including one or more signal processing and/or application-specific integrated circuits.

Wrist-wearable device 1900 with respect to FIG. 19 is an example of wearable band 1910 and watch body 1920 coupled together, so wrist-wearable device 1900 will be understood to include the components shown and described for wearable band computing system 2030 and watch body computing system 2060. In some embodiments, wrist-wearable device 1900 has a split architecture (e.g., a split mechanical architecture, a split electrical architecture, etc.) between watch body 1920 and wearable band 1910. In other words, all of the components shown in wearable band computing system 2030 and watch body computing system 2060 can be housed or otherwise disposed in a combined wrist-wearable device 1900 or within individual components of watch body 1920, wearable band 1910, and/or portions thereof (e.g., a coupling mechanism 1916 of wearable band 1910).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 1900 can be used in conjunction with a head-wearable device (e.g., AR glasses 2100 and VR system 2210) and/or an HIPD described below, and wrist-wearable device 1900 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 2100 and VR headset 2210.

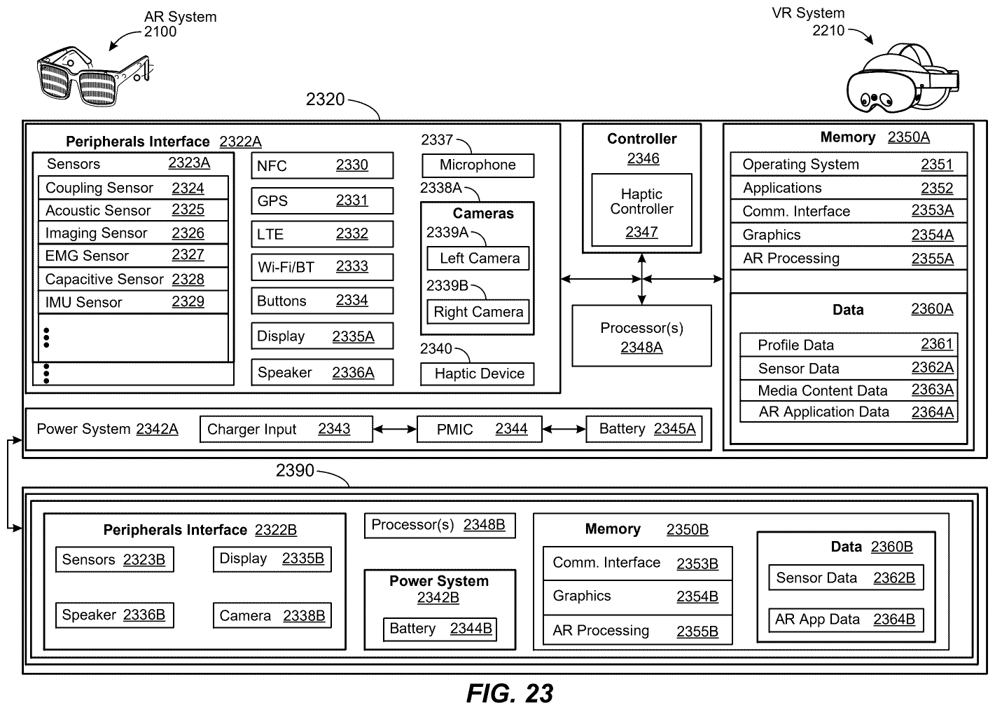

FIGS. 21 to 23 show example artificial-reality systems, which can be used as or in connection with wrist-wearable device 1900. In some embodiments, AR system 2100 includes an eyewear device 2102, as shown in FIG. 21. In some embodiments, VR system 2210 includes a head-mounted display (HMD) 2212, as shown in FIGS. 22A and 22B. In some embodiments, AR system 2100 and VR system 2210 can include one or more analogous components (e.g., components for presenting interactive artificial-reality environments, such as processors, memory, and/or presentation devices, including one or more displays and/or one or more waveguides), some of which are described in more detail with respect to FIG. 23. As described herein, a head-wearable device can include components of eyewear device 2102 and/or head-mounted display 2212. Some embodiments of head-wearable devices do not include any displays, including any of the displays described with respect to AR system 2100 and/or VR system 2210. While the example artificial-reality systems are respectively described herein as AR system 2100 and VR system 2210, either or both of the example AR systems described herein can be configured to present fully-immersive virtual-reality scenes presented in substantially all of a user's field of view or subtler augmented-reality scenes that are presented within a portion, less than all, of the user's field of view.

FIG. 21 show an example visual depiction of AR system 2100, including an eyewear device 2102 (which may also be described herein as augmented-reality glasses, and/or smart glasses). AR system 2100 can include additional electronic components that are not shown in FIG. 21, such as a wearable accessory device and/or an intermediary processing device, in electronic communication or otherwise configured to be used in conjunction with the eyewear device 2102. In some embodiments, the wearable accessory device and/or the intermediary processing device may be configured to couple with eyewear device 2102 via a coupling mechanism in electronic communication with a coupling sensor 2324 (FIG. 23), where coupling sensor 2324 can detect when an electronic device becomes physically or electronically coupled with eyewear device 2102. In some embodiments, eyewear device 2102 can be configured to couple to a housing 2390 (FIG. 23), which may include one or more additional coupling mechanisms configured to couple with additional accessory devices. The components shown in FIG. 21 can be implemented in hardware, software, firmware, or a combination thereof, including one or more signal-processing components and/or application-specific integrated circuits (ASICs).

Eyewear device 2102 includes mechanical glasses components, including a frame 2104 configured to hold one or more lenses (e.g., one or both lenses 2106-1 and 2106-2). One of ordinary skill in the art will appreciate that eyewear device 2102 can include additional mechanical components, such as hinges configured to allow portions of frame 2104 of eyewear device 2102 to be folded and unfolded, a bridge configured to span the gap between lenses 2106-1 and 2106-2 and rest on the user's nose, nose pads configured to rest on the bridge of the nose and provide support for eyewear device 2102, earpieces configured to rest on the user's ears and provide additional support for eyewear device 2102, temple arms configured to extend from the hinges to the earpieces of eyewear device 2102, and the like. One of ordinary skill in the art will further appreciate that some examples of AR system 2100 can include none of the mechanical components described herein. For example, smart contact lenses configured to present artificial reality to users may not include any components of eyewear device 2102.

Eyewear device 2102 includes electronic components, many of which will be described in more detail below with respect to FIG. 10. Some example electronic components are illustrated in FIG. 21, including acoustic sensors 2125-1, 2125-2, 2125-3, 2125-4, 2125-5, and 2125-6, which can be distributed along a substantial portion of the frame 2104 of eyewear device 2102. Eyewear device 2102 also includes a left camera 2139A and a right camera 2139B, which are located on different sides of the frame 2104. Eyewear device 2102 also includes a processor 2148 (or any other suitable type or form of integrated circuit) that is embedded into a portion of the frame 2104.

FIGS. 22A and 22B show a VR system 2210 that includes a head-mounted display (HMD) 2212 (e.g., also referred to herein as an artificial-reality headset, a head-wearable device, a VR headset, etc.), in accordance with some embodiments. As noted, some artificial-reality systems (e.g., AR system 2100) may, instead of blending an artificial reality with actual reality, substantially replace one or more of a user's visual and/or other sensory perceptions of the real world with a virtual experience (e.g., AR systems 1700 and 1800).

HMD 2212 includes a front body 2214 and a frame 2216 (e.g., a strap or band) shaped to fit around a user's head. In some embodiments, front body 2214 and/or frame 2216 include one or more electronic elements for facilitating presentation of and/or interactions with an AR and/or VR system (e.g., displays, IMUs, tracking emitter or detectors). In some embodiments, HMD 2212 includes output audio transducers (e.g., an audio transducer 2218), as shown in FIG. 22B. In some embodiments, one or more components, such as the output audio transducer(s) 2218 and frame 2216, can be configured to attach and detach (e.g., are detachably attachable) to HMD 2212 (e.g., a portion or all of frame 2216, and/or audio transducer 2218), as shown in FIG. 22B. In some embodiments, coupling a detachable component to HMD 2212 causes the detachable component to come into electronic communication with HMD 2212.

FIGS. 22A and 22B also show that VR system 2210 includes one or more cameras, such as left camera 2239A and right camera 2239B, which can be analogous to left and right cameras 2139A and 2139B on frame 2104 of eyewear device 2102. In some embodiments, VR system 2210 includes one or more additional cameras (e.g., cameras 2239C and 2239D), which can be configured to augment image data obtained by left and right cameras 2239A and 2239B by providing more information. For example, camera 2239C can be used to supply color information that is not discerned by cameras 2239A and 2239B. In some embodiments, one or more of cameras 2239A to 2239D can include an optional IR cut filter configured to remove IR light from being received at the respective camera sensors.

FIG. 23 illustrates a computing system 2320 and an optional housing 2390, each of which show components that can be included in AR system 2100 and/or VR system 2210. In some embodiments, more or fewer components can be included in optional housing 2390 depending on practical restraints of the respective AR system being described.

In some embodiments, computing system 2320 can include one or more peripherals interfaces 2322A and/or optional housing 2390 can include one or more peripherals interfaces 2322B. Each of computing system 2320 and optional housing 2390 can also include one or more power systems 2342A and 2342B, one or more controllers 2346 (including one or more haptic controllers 2347), one or more processors 2348A and 2348B (as defined above, including any of the examples provided), and memory 2350A and 2350B, which can all be in electronic communication with each other. For example, the one or more processors 2348A and 2348B can be configured to execute instructions stored in memory 2350A and 2350B, which can cause a controller of one or more of controllers 2346 to cause operations to be performed at one or more peripheral devices connected to peripherals interface 2322A and/or 2322B. In some embodiments, each operation described can be powered by electrical power provided by power system 2342A and/or 2342B.

In some embodiments, peripherals interface 2322A can include one or more devices configured to be part of computing system 2320, some of which have been defined above and/or described with respect to the wrist-wearable devices shown in FIGS. 19 and 20. For example, peripherals interface 2322A can include one or more sensors 2323A. Some example sensors 2323A include one or more coupling sensors 2324, one or more acoustic sensors 2325, one or more imaging sensors 2326, one or more EMG sensors 2327, one or more capacitive sensors 2328, one or more IMU sensors 2329, and/or any other types of sensors explained above or described with respect to any other embodiments discussed herein.

In some embodiments, peripherals interfaces 2322A and 2322B can include one or more additional peripheral devices, including one or more NFC devices 2330, one or more GPS devices 2331, one or more LTE devices 2332, one or more Wi-Fi and/or Bluetooth devices 2333, one or more buttons 2334 (e.g., including buttons that are slidable or otherwise adjustable), one or more displays 2335A and 2335B, one or more speakers 2336A and 2336B, one or more microphones 2337, one or more cameras 2338A and 2338B (e.g., including the left camera 2339A and/or a right camera 2339B), one or more haptic devices 2340, and/or any other types of peripheral devices defined above or described with respect to any other embodiments discussed herein.

AR systems can include a variety of types of visual feedback mechanisms (e.g., presentation devices). For example, display devices in AR system 2100 and/or VR system 2210 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 2335A and 2335B can be coupled to each of the lenses 2106-1 and 2106-2 of AR system 2100. Displays 2335A and 2335B may be coupled to each of lenses 2106-1 and 2106-2, which can act together or independently to present an image or series of images to a user. In some embodiments, AR system 2100 includes a single display 2335A or 2335B (e.g., a near-eye display) or more than two displays 2335A and 2335B. In some embodiments, a first set of one or more displays 2335A and 2335B can be used to present an augmented-reality environment, and a second set of one or more display devices 2335A and 2335B can be used to present a virtual-reality environment. In some embodiments, one or more waveguides are used in conjunction with presenting artificial-reality content to the user of AR system 2100 (e.g., as a means of delivering light from one or more displays 2335A and 2335B to the user's eyes). In some embodiments, one or more waveguides are fully or partially integrated into the eyewear device 2102. Additionally, or alternatively to display screens, some artificial-reality systems include one or more projection systems. For example, display devices in AR system 2100 and/or VR system 2210 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 2335A and 2335B.

Computing system 2320 and/or optional housing 2390 of AR system 2100 or VR system 2210 can include some or all of the components of a power system 2342A and 2342B. Power systems 2342A and 2342B can include one or more charger inputs 2343, one or more PMICs 2344, and/or one or more batteries 2345A and 2344B.

Memory 2350A and 2350B may include instructions and data, some or all of which may be stored as non-transitory computer-readable storage media within the memories 2350A and 2350B. For example, memory 2350A and 2350B can include one or more operating systems 2351, one or more applications 2352, one or more communication interface applications 2353A and 2353B, one or more graphics applications 2354A and 2354B, one or more AR processing applications 2355A and 2355B, and/or any other types of data defined above or described with respect to any other embodiments discussed herein.

Memory 2350A and 2350B also include data 2360A and 2360B, which can be used in conjunction with one or more of the applications discussed above. Data 2360A and 2360B can include profile data 2361, sensor data 2362A and 2362B, media content data 2363A, AR application data 2364A and 2364B, and/or any other types of data defined above or described with respect to any other embodiments discussed herein.

In some embodiments, controller 2346 of eyewear device 2102 may process information generated by sensors 2323A and/or 2323B on eyewear device 2102 and/or another electronic device within AR system 2100. For example, controller 2346 can process information from acoustic sensors 2125-1 and 2125-2. For each detected sound, controller 2346 can perform a direction of arrival (DOA) estimation to estimate a direction from which the detected sound arrived at eyewear device 2102 of R system 2100. As one or more of acoustic sensors 2325 (e.g., the acoustic sensors 2125-1, 2125-2) detects sounds, controller 2346 can populate an audio data set with the information (e.g., represented in FIG. 10 as sensor data 2362A and 2362B).

In some embodiments, a physical electronic connector can convey information between eyewear device 2102 and another electronic device and/or between one or more processors 2148, 2348A, 2348B of AR system 2100 or VR system 2210 and controller 2346. The information can be in the form of optical data, electrical data, wireless data, or any other transmittable data form. Moving the processing of information generated by eyewear device 2102 to an intermediary processing device can reduce weight and heat in the eyewear device, making it more comfortable and safer for a user. In some embodiments, an optional wearable accessory device (e.g., an electronic neckband) is coupled to eyewear device 2102 via one or more connectors. The connectors can be wired or wireless connectors and can include electrical and/or non-electrical (e.g., structural) components. In some embodiments, eyewear device 2102 and the wearable accessory device can operate independently without any wired or wireless connection between them.

In some situations, pairing external devices, such as an intermediary processing device (e.g., HIPD 1506, 1606, 1706) with eyewear device 2102 (e.g., as part of AR system 2100) enables eyewear device 2102 to achieve a similar form factor of a pair of glasses while still providing sufficient battery and computation power for expanded capabilities. Some, or all, of the battery power, computational resources, and/or additional features of AR system 2100 can be provided by a paired device or shared between a paired device and eyewear device 2102, thus reducing the weight, heat profile, and form factor of eyewear device 2102 overall while allowing eyewear device 2102 to retain its desired functionality. For example, the wearable accessory device can allow components that would otherwise be included on eyewear device 2102 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 2102 standing alone. Because weight carried in the wearable accessory device can be less invasive to a user than weight carried in the eyewear device 2102, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 2100 and/or VR system 2210 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 22A and 22B show VR system 2210 having cameras 2239A to 2239D, which can be used to provide depth information for creating a voxel field and a two-dimensional mesh to provide object information to the user to avoid collisions.

In some embodiments, AR system 2100 and/or VR system 2210 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 2100 and/or VR system 2210, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data, output a result of the transformation to a display, use the result of the transformation to modulate pixel pulses, and store the result of the transformation to subdivide pulses. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
receiving a pulse width value corresponding to a pulse for activating a pixel of a color channel for a frame;
dividing the pulse into a plurality of sub-pulses; and
activating the pixel for the frame based on the plurality of sub-pulses.

2. The method of claim 1, wherein activating the pixel further comprises interleaving active periods corresponding to the plurality of sub-pulses with inactive periods.

3. The method of claim 1, further comprising:
receiving a second pulse width value corresponding to a second pulse for activating a second pixel of a second color channel for the frame;
dividing the second pulse into a second plurality of sub-pulses; and
activating the second pixel for the frame based on the second plurality of sub-pulses.

4. The method of claim 3, wherein a ratio between the pulse and the second pulse is maintained for the plurality of sub-pulses and the second plurality of sub-pulses.

5. The method of claim 4, wherein dividing the pulse into the plurality of sub-pulses is based on the ratio satisfying a ratio threshold.

6. The method of claim 1, wherein the pulse width value corresponds to a bit sequence representing decreasing numbers of cycles from a most significant bit (MSB) of the bit sequence to a least significant bit (LSB) of the bit sequence.

7. The method of claim 6, wherein dividing the pulse into the plurality of sub-pulses includes interleaving cycles represented by different bit values.

8. The method of claim 7, further comprising interleaving the cycles using a counter circuit.

9. The method of claim 1, further comprising:
receiving, from a neighboring pixel, a second pulse width value before the frame ends;
sending, to a second neighboring pixel, the pulse width value;
dividing the second pulse width value into a second plurality of sub-pulses; and
activating the pixel for a remainder of the frame based on the second plurality of sub-pulses.

10. A device comprising:
a pixel circuit corresponding to a color channel;
a plurality of bit circuits coupled to the pixel circuit; and
a control circuit coupled to the plurality of bit circuits and configured to:
receive a pulse width value corresponding to a pulse for activating the pixel circuit for a frame;
divide the pulse into a plurality of sub-pulses; and
activate the pixel circuit for the frame based on the plurality of sub-pulses.

11. The device of claim 10, wherein the control circuit is configured to interleave active periods corresponding to the plurality of sub-pulses with inactive periods.

12. The device of claim 10, further comprising a second pixel circuit corresponding to a second color channel;
wherein the control circuit is configured to:
receive a second pulse width value corresponding to a second pulse for activating the second pixel circuit for the frame;
divide the second pulse into a second plurality of sub-pulses; and
activate the second pixel circuit for the frame based on the second plurality of sub-pulses.

13. The device of claim 12, wherein a ratio between the pulse and the second pulse is maintained for the plurality of sub-pulses and the second plurality of sub-pulses.

14. The device of claim 13, wherein dividing the pulse into the plurality of sub-pulses is based on the ratio satisfying a ratio threshold.

15. The device of claim 10, wherein the pulse width value corresponds to a bit sequence representing decreasing numbers of cycles from a most significant bit (MSB) of the bit sequence to a least significant bit (LSB) of the bit sequence.

16. The device of claim 15, wherein dividing the pulse into the plurality of sub-pulses includes interleaving cycles represented by different bit values.

17. The device of claim 16, further comprising interleaving the cycles using a counter circuit.

18. The device of claim 10, wherein the control circuit is configured to:
receive, from a neighboring pixel, a second pulse width value before the frame ends;
send, to a second neighboring pixel, the pulse width value;
divide the second pulse width value into a second plurality of sub-pulses; and
activate the pixel for a remainder of the frame based on the second plurality of sub-pulses.

19. A device comprising:
a plurality of pixels; and
a control circuit coupled to the plurality of pixels and configured to, for each pixel:
receive a pulse width value corresponding to a pulse for activating the pixel for a frame;
divide the pulse into a plurality of sub-pulses; and
activate the pixel for the frame based on the plurality of sub-pulses.

20. The device of claim 19 wherein the control circuit is configured to:
send the pulse width value to a neighboring pixel before the frame ends;
divide the pulse width value into a second plurality of sub-pulses; and
activate the neighboring pixel for a remainder of the frame based on the second plurality of sub-pulses.
